(19) United States
(12) Patent Application Publication
(10) Pub. No.: US 2026/0040196 A1
(43) Pub. Date: Feb. 5, 2026

(54) MOBILITY CONFIGURATION METHOD AND APPARATUS

(71) Applicant: BEIJING XIAOMI MOBILE SOFTWARE CO., LTD., Beijing (CN)

(72) Inventors: Yi XIONG, Beijing (CN); Yumin WU, Beijing (CN)

(21) Appl. No.: 18/998,165

(22) PCT Filed: Jul. 28, 2022
(86) PCT No.: PCT/CN2022/108751

§ 371 Date: Jan. 24, 2025

(51) Int. Cl. H04W 48/16; H04W 40/24

(52) U.S. Cl. CPC H04W 48/16; H04W 40/24

(57) ABSTRACT

A mobility configuration method and a communication device are provided. The method is performed by a first network device, and includes: sending an update message or a cancel message to a second network device. The update message is configured to update a mobility configuration of a terminal, and the cancel message is configured to cancel a mobility operation corresponding to the first network device in the terminal.

### CROSS-REFERENCE TO RELATED APPLICATION

The present application is a U.S. National Stage of International Application No. PCT/CN2022/108751, filed on Jul. 28, 2022, the contents of which are incorporated herein by reference in their entireties for all purposes.

### BACKGROUND

Conditional handover (CHO) is proposed in R16, and conditional primary secondary cell (PSCell) change (CPC) and conditional PSCell addition (CPA) are proposed in R17. The terminal must release the CHO/CPC/CPA configuration when completing random access to the target primary cell (PCell)/PSCell. Therefore, if the terminal intends to continue to execute CHO/CPC/CPA in the future, the network needs to reconfigure or initialize the corresponding CHO/CPC/CPA configuration, which will increase the time delay of handover or change of the secondary cell group and increase the signal overhead, especially in a case when the cell group is changed frequently.

Therefore, in R18, the selective activation of cell groups in multi-radio dual connectivity (MR-DC) is proposed, such that the terminal can still perform the configuration after the cell group is changed without reconfiguration or initialization of the network device, thus reducing the signaling overhead and time delay.

### SUMMARY

The present disclosure relates to a field of communication, and more particularly to a mobility configuration method and a device.

Embodiments of a first aspect of the present disclosure provide a mobility configuration method, which is performed by a first network device, and includes: sending an update message or a cancel message to a second network device. The update message is configured to update a mobility configuration of a terminal, and the cancel message is configured to cancel a mobility operation corresponding to the first network device in the terminal.

Embodiments of a second aspect of the present disclosure provide a mobility configuration method, which is performed by a first network device, and includes: receiving a cancel message sent by a second network device. The cancel message is configured to cancel a mobility operation corresponding to the first network device in a terminal.

Embodiments of a third aspect of the present disclosure provide a mobility configuration method, which is performed by a currently activated network device, and includes: receiving an update message or a cancel message sent by a first network device; and sending the update message or the cancel message to a terminal. The currently activated network device is a network device corresponding to a currently activated cell or cell group, the update message is configured to update a mobility configuration of the terminal, and the cancel message is configured to cancel a mobility operation corresponding to the first network device in the terminal.

Embodiments of a fourth aspect of the present disclosure provide a mobility configuration method, which is performed by a currently activated network device, and includes: sending a cancel message to a first network device; and sending the cancel message to a terminal. The currently activated network device is a network device corresponding to a currently activated cell or cell group, and the cancel message is configured to cancel a mobility operation corresponding to the first network device in the terminal.

Embodiments of a fifth aspect of the present disclosure provide a mobility configuration method, which is performed by an anchor network device, and includes: receiving an update message or a cancel message sent by a first network device; and sending the update message or the cancel message to the currently activated network device. The currently activated network device is a network device corresponding to a currently activated cell or cell group, the update message is configured to update a mobility configuration of a terminal, and the cancel message is configured to cancel a mobility operation corresponding to the first network device in the terminal.

Embodiments of a sixth aspect of the present disclosure provide a mobility configuration method, which is performed by an anchor network device, and includes: sending a cancel message to a first network device. The cancel message is configured to cancel a mobility operation corresponding to the first network device in a terminal.

Embodiments of a seventh aspect of the present disclosure provide a mobility configuration apparatus, which is applied to a first network device, and includes a transceiver unit configured to send an update message or a cancel message to a second network device. The update message is configured to update a mobility configuration of a terminal, and the cancel message is configured to cancel a mobility operation corresponding to the first network device in the terminal.

Embodiments of an eighth aspect of the present disclosure provide a mobility configuration apparatus, which is applied to a first network device, and includes a transceiver unit configured to receive a cancel message sent by a second network device. The cancel message is configured to cancel a mobility operation corresponding to the first network device in a terminal.

Embodiments of a ninth aspect of the present disclosure provide a mobility configuration apparatus, which is applied to a currently activated network device, and includes a transceiver unit. The transceiver unit is configured to: receive an update message or a cancel message sent by a first network device; and send the update message or the cancel message to a terminal. The currently activated network device is a network device corresponding to a currently activated cell or cell group, the update message is configured to update a mobility configuration of the terminal, and the cancel message is configured to cancel a mobility operation corresponding to the first network device in the terminal.

Embodiments of a tenth aspect of the present disclosure provide a mobility configuration apparatus, which is applied to a currently activated network device, and includes a transceiver unit. The transceiver unit is configured to: send a cancel message to a first network device; and send the cancel message to a terminal. The currently activated network device is a network device corresponding to a currently activated cell or cell group, and the cancel message is configured to cancel a mobility operation corresponding to the first network device in the terminal.

Embodiments of an eleventh aspect of the present disclosure provide a mobility configuration apparatus, which is applied to an anchor network device, and includes a transceiver unit. The transceiver unit is configured to: receive an update message or a cancel message sent by a first network device; and send the update message or the cancel message to the currently activated network device. The currently activated network device is a network device corresponding to a currently activated cell or cell group, the update message is configured to update a mobility configuration of a terminal, and the cancel message is configured to cancel a mobility operation corresponding to the first network device in the terminal.

Embodiments of a twelfth aspect of the present disclosure provide a mobility configuration apparatus, which is applied to an anchor network device, and includes a transceiver unit. The transceiver unit is configured to: send a cancel message to a first network device. The cancel message is configured to cancel a mobility operation corresponding to the first network device in a terminal.

Embodiments of a thirteenth aspect of the present disclosure provide a communication device, which includes a processor and a memory. A computer program is stored in the memory, and the processor executes the computer program stored in the memory, so that the device performs the mobility configuration method according to the embodiments of the first aspect or the mobility configuration method according to the embodiments of the second aspect.

Embodiments of a fourteenth aspect of the present disclosure provide a communication device, which includes a processor and a memory. A computer program is stored in the memory, and the processor executes the computer program stored in the memory, so that the device performs the mobility configuration method according to the embodiments of the third aspect or the mobility configuration method according to the embodiments of the fourth aspect.

Embodiments of a fifteenth aspect of the present disclosure provide a communication device, which includes a processor and a memory. A computer program is stored in the memory, and the processor executes the computer program stored in the memory, so that the device perform the mobility configuration method according to the embodiments of the fifth aspect or the mobility configuration method according to the embodiments of the sixth aspect.

Embodiments of a sixteenth aspect of the present disclosure provide a communication device, which includes a processor and an interface circuit. The interface circuit is configured to receive code instructions and transmit the code instructions to the processor, and the processor is configured to execute the code instructions to cause the device perform the mobility configuration method according to the embodiments of the first aspect or the mobility configuration method according to the embodiments of the second aspect.

Embodiments of a seventeenth aspect of the present disclosure provide a communication device, which includes a processor and an interface circuit. The interface circuit is configured to receive code instructions and transmit the code instructions to the processor, and the processor is configured to execute the code instructions to cause the device perform the mobility configuration method according to the embodiments of the third aspect or the mobility configuration method according to the embodiments of the fourth aspect.

Embodiments of an eighteenth aspect of the present disclosure provide a communication device, which includes a processor and an interface circuit. The interface circuit is configured to receive code instructions and transmit the code instructions to the processor, and the processor is configured to execute the code instructions to cause the device to perform the mobility configuration method according to the embodiments of the fifth aspect or the mobility configuration method according to the embodiments of the sixth aspect.

Embodiments of a nineteenth aspect of the present disclosure provide a computer-readable storage medium for storing instructions, which, when executed, cause the mobility configuration method according to the embodiments of the first aspect to be realized or cause the mobility configuration method according to the embodiments of the second aspect to be realized.

Embodiments of a twentieth aspect of the present disclosure provides a computer-readable storage medium for storing instructions, which, when executed, cause the mobility configuration method according to the embodiments of the third aspect or the mobility configuration method according to the embodiments of the fourth aspect to be realized.

Embodiments of a twenty-first aspect of the present disclosure provide a computer-readable storage medium for storing instructions, which, when executed, cause the mobility configuration method according to the embodiments of the fifth aspect or the mobility configuration method according to the embodiments of the sixth aspect to be realized.

Embodiments of a twenty-second aspect of the present disclosure provide a computer program, which, when run on a computer, causes the computer to perform the mobility configuration method according to the embodiments of the first aspect or the mobility configuration method according to the embodiments of the second aspect.

Embodiments of a twenty-third aspect of the present disclosure provide a computer program, which, when run on a computer, causes the computer to perform the mobility configuration method according to the embodiments of the third aspect or the mobility configuration method according to the embodiments of the fourth aspect.

Embodiments of a twenty-fourth aspect of the present disclosure provide a computer program, which, when run on a computer, causes the computer to perform the mobility configuration method according to the embodiments of the fifth aspect or the mobility configuration method according to the embodiments of the sixth aspect.

Additional aspects and advantages of that present disclosure will be set forth in part in the following description, and in part will be obvious from the following description, or may be understood by practice of the present disclosure.

### BRIEF DESCRIPTION OF THE DRAWINGS

In order to more clearly explain the technical solutions in the embodiments of the present disclosure or in the related art, the accompanying drawings needed to be used in the embodiments of the present disclosure or in the related art will be described below.

FIG. 1a is a schematic architecture diagram of a communication system provided by an embodiment of the present disclosure.

FIG. 1b is a schematic architecture diagram of a dual connection system provided by an embodiment of the present disclosure.

FIG. 2 is a flow chart of a mobility configuration method provided by an embodiment of the present disclosure.

FIG. 3 is a flow chart of a mobility configuration method provided by an embodiment of the present disclosure.

FIG. 4 is a flow chart of a mobility configuration method provided by an embodiment of the present disclosure.

FIG. 5 is a flow chart of a mobility configuration method provided by an embodiment of the present disclosure.

FIG. 6 is a flow chart of a mobility configuration method provided by an embodiment of the present disclosure.

FIG. 7 is a flow chart of a mobility configuration method provided by an embodiment of the present disclosure.

FIG. 8a is a flow chart of a mobility configuration method provided by an embodiment of the present disclosure.

FIG. 8b is a flow chart of a mobility configuration method provided by an embodiment of the present disclosure.

FIG. 8c is a flow chart of a mobility configuration method provided by an embodiment of the present disclosure.

FIG. 8d is a flow chart of a mobility configuration method provided by an embodiment of the present disclosure.

FIG. 8e is a flow chart of a mobility configuration method provided by an embodiment of the present disclosure.

FIG. 8f is a flow chart of a mobility configuration method provided by an embodiment of the present disclosure.

FIG. 9 is a flow chart of a mobility configuration method provided by an embodiment of the present disclosure.

FIG. 10a is a flow chart of a mobility configuration method provided by an embodiment of the present disclosure.

FIG. 10b is a flow chart of a mobility configuration method provided by an embodiment of the present disclosure.

FIG. 10c is a flow chart of a mobility configuration method provided by an embodiment of the present disclosure.

FIG. 10d is a flow chart of a mobility configuration method provided by an embodiment of the present disclosure.

FIG. 10e is a flow chart of a mobility configuration method provided by an embodiment of the present disclosure.

FIG. 10f is a flow chart of a mobility configuration method provided by an embodiment of the present disclosure.

FIG. 11 is a flow chart of a mobility configuration method provided by an embodiment of the present disclosure.

FIG. 12a is a flow chart of a mobility configuration method provided by an embodiment of the present disclosure.

FIG. 12b is a flow chart of a mobility configuration method provided by an embodiment of the present disclosure.

FIG. 12c is a flow chart of a mobility configuration method provided by an embodiment of the present disclosure.

FIG. 12d is a flow chart of a mobility configuration method provided by an embodiment of the present disclosure.

FIG. 12e is a flow chart of a mobility configuration method provided by an embodiment of the present disclosure.

FIG. 12f is a flow chart of a mobility configuration method provided by an embodiment of the present disclosure.

FIG. 13 is a flow chart of a mobility configuration method provided by an embodiment of the present disclosure.

FIG. 14a is a flow chart of a mobility configuration method provided by an embodiment of the present disclosure.

FIG. 14b is a flow chart of a mobility configuration method provided by an embodiment of the present disclosure.

FIG. 14c is a flow chart of a mobility configuration method provided by an embodiment of the present disclosure.

FIG. 14d is a flow chart of a mobility configuration method provided by an embodiment of the present disclosure.

FIG. 15 is a flow chart of a mobility configuration method provided by an embodiment of the present disclosure.

FIG. 16a is a flow chart of a mobility configuration method provided by an embodiment of the present disclosure.

FIG. 16b is a flow chart of a mobility configuration method provided by an embodiment of the present disclosure.

FIG. 16c is a flow chart of a mobility configuration method provided by an embodiment of the present disclosure.

FIG. 16d is a flow chart of a mobility configuration method provided by an embodiment of the present disclosure.

FIG. 17 is a flow chart of a mobility configuration method provided by an embodiment of the present disclosure.

FIG. 18a is a flow chart of a mobility configuration method provided by an embodiment of the present disclosure.

FIG. 18b is a flow chart of a mobility configuration method provided by an embodiment of the present disclosure.

FIG. 18c is a flow chart of a mobility configuration method provided by an embodiment of the present disclosure.

FIG. 18d is a flow chart of a mobility configuration method provided by an embodiment of the present disclosure.

FIG. 19 is a flow chart of a mobility configuration method provided by an embodiment of the present disclosure.

FIG. 20a is a flow chart of a mobility configuration method provided by an embodiment of the present disclosure.

FIG. 20b is a flow chart of a mobility configuration method provided by an embodiment of the present disclosure.

FIG. 20c is a flow chart of a mobility configuration method provided by an embodiment of the present disclosure.

FIG. 20d is a flow chart of a mobility configuration method provided by an embodiment of the present disclosure.

FIG. 21 is a flow chart of a mobility configuration method provided by an embodiment of the present disclosure.

FIG. 22 is a schematic diagram of a node path table provided by an embodiment of the present disclosure.

FIG. 23a is a flow chart of a mobility configuration method provided by an embodiment of the present disclosure.

FIG. 23b is a flow chart of a mobility configuration method provided by an embodiment of the present disclosure.

FIG. 23c is a flow chart of a mobility configuration method provided by an embodiment of the present disclosure.

FIG. 23d is a flow chart of a mobility configuration method provided by an embodiment of the present disclosure.

FIG. 24 is a flow chart of a mobility configuration method provided by an embodiment of the present disclosure.

FIG. 25 is a schematic diagram of a node connection relationship provided by an embodiment of the present disclosure.

FIG. 26a is a flow chart of a mobility configuration method provided by an embodiment of the present disclosure.

FIG. 26b is a flow chart of a mobility configuration method provided by an embodiment of the present disclosure.

FIG. 26c is a flow chart of a mobility configuration method provided by an embodiment of the present disclosure.

FIG. 26d is a flow chart of a mobility configuration method provided by an embodiment of the present disclosure.

FIG. 27 is a flow chart of a mobility configuration method provided by an embodiment of the present disclosure.

FIG. 28 is a schematic diagram of information interaction between network devices provided by an embodiment of the present disclosure.

FIG. 29 is a schematic diagram of a mobility configuration apparatus provided by an embodiment of the present disclosure.

FIG. 30 is a schematic diagram of a mobility configuration apparatus provided by an embodiment of the present disclosure.

FIG. 31 is a schematic diagram of a mobility configuration apparatus provided by an embodiment of the present disclosure.

FIG. 32 is a schematic diagram of a mobility configuration apparatus provided by an embodiment of the present disclosure.

FIG. 33 is a schematic diagram of a mobility configuration apparatus provided by an embodiment of the present disclosure.

FIG. 34 is a schematic diagram of a mobility configuration apparatus provided by an embodiment of the present disclosure.

FIG. 35 is a schematic diagram of another mobility configuration apparatus provided by an embodiment of the present disclosure.

FIG. 36 is a schematic diagram of a chip provided by an embodiment of the present disclosure.

### DETAILED DESCRIPTION

Reference will now be made in detail to illustrative embodiments, examples of which are illustrated in the accompanying drawings. When the following description refers to the drawings, unless otherwise indicated, the same numbers in different drawings indicate the same or similar elements. The implementations described in the following illustrative embodiments do not represent all the implementations consistent with the embodiments of the present disclosure. Rather, they are merely examples of apparatuses and methods consistent with some aspects of the embodiments of the present disclosure as detailed in the appended claims.

The terms used in the embodiments of the present disclosure are only for the purpose of describing specific embodiments, and are not intended to limit the embodiments of the present disclosure. The singular forms “a” and “the” used in the embodiments of the present disclosure and the appended claims are also intended to include the plural forms, unless otherwise clearly indicated in context. It should also be understood that the term “and/or” as used herein refers to and includes any or all possible combinations of one or more associated listed items.

It should be understood that although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be called the second information, and similarly, the second information may also be called the first information. Depending on the context, the word “if” as used herein may be interpreted as “when” or “as” or “in response to determining”.

Hereinafter, embodiments of the present disclosure will be described in detail, examples of which are illustrated in the accompanying drawings, wherein the same or similar reference numerals indicate the same or similar elements throughout. The embodiments described below by referring to the accompanying drawings are illustrative and are intended to explain the present disclosure, but not to be construed as limitations to the present disclosure.

It should be noted that in the present disclosure, a method provided by any embodiment may be performed alone, and any implementation in the embodiments may also be performed alone, or in combination with other embodiments, or possible implementation methods in other embodiments, or in combination with any technical solution in the related art.

In order to better understand a mobility configuration method disclosed in embodiments of the present disclosure, a communication system to which the embodiments of the present disclosure applies will be described below.

As shown in FIG. 1a, FIG. 1a is a schematic architecture diagram of a communication system provided by an embodiment of the present disclosure. The communication system may include, but is not limited to, one terminal and two network devices. The number and form of devices shown in FIG. 1a are only for example and do not constitute limitations to the embodiments of the present disclosure. In practical applications, two or more network devices and two or more terminals may be included. The communication system shown in FIG. 1a includes a terminal 101, a network device 102 and a network device 103 as an example.

It should be noted that the technical solution of the embodiments of the present disclosure may be applied to various communication systems. For example, the long term evolution (LTE) system, the fifth generation mobile communication system, the 5G new radio system, or other new mobile communication systems in the future.

The terminal 101 in the embodiments of the present disclosure is an entity on a user side for receiving or transmitting signals, such as a mobile phone. The terminal may also be called a terminal device, a user equipment (UE), a mobile station (MS), a mobile terminal (MT) and so on. The terminal may be a vehicle with a communication function, a smart vehicle, a mobile phone, a wearable device, a Pad, a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The embodiments of the present disclosure do not limit the specific technology and the specific device form adopted by the terminal.

The network device 102 and the network device 103 in the embodiments of the present disclosure are entities on a network side for transmitting or receiving signals. For example, the network device 102 and the network device 103 may be an evolved NodeB (eNB), a transmission reception point (TRP), a next generation NodeB (gNB) in the NR system, a base station in other future mobile communication systems or an access node in a wireless fidelity (WiFi) system. The embodiments of the present disclosure do not limit the specific technology and the specific device form adopted by the network device. The network device provided by the embodiments of the present disclosure may be composed of a central unit (CU) and a distributed unit (DU), in which the CU may also be called a control unit. With the structure of CU-DU, the network device, such as the protocol layers of the base station, may be separated, and the functions of some protocol layers are centrally controlled by the CU, while the functions of some or all of the remaining protocol layers are distributed in the DU, and the DU is centrally controlled by the CU.

The network device in the embodiments of the present disclosure may include nodes. The node may be a master node (MN) or a secondary node (SN), the master node MN corresponds to a master cell group (MCG) of the terminal and the secondary node SN corresponds to a secondary cell group (SCG) of the terminal.

The multi-radio dual connectivity (MR-DC) is a generalized dual connection between evolved universal terrestrial radio access (Intra-E-UTRAs, E-UTRAs). The terminal 101 may utilize radio resources provided by two different schedules, which are located on two different next generation-radio access network (NG-RAN) nodes (such as the network device 102 and the network device 103 in FIG. 1a). Through non-ideal backhaul connection, one provides NR access and the other provides E-UTRA or NR access. One serves as the primary node and the other serves as the secondary node. The MN and the SN are connected through a network interface, and at least the MN is connected to the core network.

Under the dual connection, the UE may access two cell groups, namely the master cell group and the secondary cell group, as shown in FIG. 1b. Under the MCG, there may be many cells, one of the cells is configured for initiating initial access, and this cell is called a primary cell (PCell). As the name implies, the PCell is the most “primary” cell in the MCG. The PCell under the MCG and a secondary cell (SCell) under the MCG are coupled by carrier aggregation (CA). The primary cell in the MCG is denoted as PCell and the secondary cell in the MCG is denoted as SCell. The primary cell in the SCG is called a primary secondary cell (PSCell), and the secondary cell in the SCG is denoted as SCell. Since a lot of signaling is only sent on the PCell and the PSCell, for the convenience of description, the protocol also defines a concept of a special cell (sPCell), and the PCell and the PSCell are collectively referred to as the sPCell.

Conditional handover (CHO) is proposed in R16, and conditional primary secondary cell change (CPC) and conditional primary secondary cell addition (CPA) are proposed in R17. The terminal must release the CHO/CPC/CPA configuration when completing random access to a target PCell/PSCell. Therefore, if the terminal intends to continue to execute CHO/CPC/CPA in the future, the network needs to reconfigure or initialize the corresponding CHO/CPC/CPA configuration, which will increase the time delay of handover or change of the secondary cell group and increase the signal overhead, especially in a case that the cell group is changed frequently.

Therefore, in R18, the selective activation of cell groups in MR-DC is proposed, and the network side provides the “cell group to be activated”, so that the terminal may still perform the configuration after the cell group is changed without reconfiguration or initialization of the network device, which can decrease the signaling overhead and reduce the waste of resources.

Cell group selective activation configuration information may include at least one of: a configuration ID, an activation condition (possible), and a configuration of the cell group/cell to be activated.

The selective activation of the cell group may allow the subsequent configuration to be still executed after the cell group is changed, and the network does not need to reconfigure or reinitialize the corresponding configuration of the cell group selective activation. Therefore, in the selective activation of the cell groups, the network device may provide the “cell group to be activated” for the terminal. Subsequently, the “cell group to be activated” may be activated or deactivated without providing the configuration of the cell group again.

In the selective activation of the cell groups, the network device may provide a preconfigured candidate target cell group or target cell to the terminal. Subsequently, the terminal may activate or deactivate the preconfigured candidate cell group or cell according to a corresponding activation event or a configuration (such as an activation message) issued by the network device, without providing the configuration of the cell group again. Alternatively, it may be understood that in the cell group selective activation, the terminal will not delete the corresponding configuration information of the cell group selective activation after activating a new cell or cell group, or after applying a new cell configuration or cell group configuration or accessing a new cell or cell group.

The selective activation of the cell groups may also be called a cell group activation. The cell group activation may allow the corresponding configuration information to be still executed after the cell group or cell changes, and the network does not need to reconfigure or reinitialize the corresponding configuration information of the cell group activation. Therefore, the cell group activation may reduce the signaling overhead and the interruption duration of the cell group change. The configuration information of the cell group activation may include a configuration ID and a configuration of the target cell or a configuration of the target cell group. In some embodiments, the configuration information of the cell group activation may also include a trigger condition (also called an execution condition and an activation condition).

In an embodiment, the cell group activation is a mobility management process, which includes any mobility management process in which by configuring the cell group activation configuration, the terminal activates or deactivates the corresponding cell or cell group, or applies the corresponding cell configuration or cell group configuration, or accesses the cell or cell group according to the signaling sent by the network, or the criteria specified by the protocol, or in an autonomous way.

In an embodiment, the cell group activation is a mobility management process, including any mobility management process in which part or all of the corresponding configuration information is not deleted or released after performing a mobility process. Not deleting or releasing the part or all of the corresponding configuration information may also be called retaining the part or all of the corresponding configuration information.

In the present disclosure, the cell group includes one or more of the master cell group (MCG) and the secondary cell group (SCG). The MCG includes one or more of the primary cell (PCell) and the secondary cell (SCell). The SCG includes one or more of the primary secondary cell (PSCell) and the secondary cell (SCell).

In the present disclosure, the cell group selective activation may include a cell selective activation or a cell activation, for example, one or more of a PCell activation, a PSCell activation and a SCell activation.

In the cell group selective activation, in order for the terminal to continue to perform the subsequent cell group change or activation after the cell group is changed and without reconfiguration or reinitialization, in the cell group selective activation of R18, the change of a current serving cell of the terminal 101 will not trigger a source node corresponding to a source serving cell to release the context of the terminal 101, and also an unselected target node will not be triggered through the source node to release the resources reserved for the terminal 101.

Due to the characteristics of the cell group selective activation, the terminal 101 may retain a mobility configuration that is not configured by the current serving node. For the reliability of the mobility configuration, the network side may initiate the update of the mobility configuration of the terminal side or cancel the corresponding mobility operation. However, for the mobility configuration that is not configured by the current serving node, the current serving node may not know that the terminal 101 has this mobility configuration and the cell/cell group/node corresponding to this configuration, and the node corresponding to this configuration may not know the current cell. Therefore, the network side cannot start the update of these mobility configurations or cancel the mobility operations, which will affect the reliability of the mobility.

It may be understood that the communication system described in the embodiments of the present disclosure is for more clearly explaining the technical solution of the embodiments of the present disclosure, and does not constitute limitations on the technical solution provided by the embodiments of the present disclosure. As those ordinary skilled in the art know, with the evolution of the system architecture and the emergence of new business scenarios, the technical solution provided by the embodiments of the present disclosure is also applicable to similar technical problems.

Next, the mobility configuration method and apparatus provided by the present disclosure will be introduced in detail with reference to the accompanying drawings.

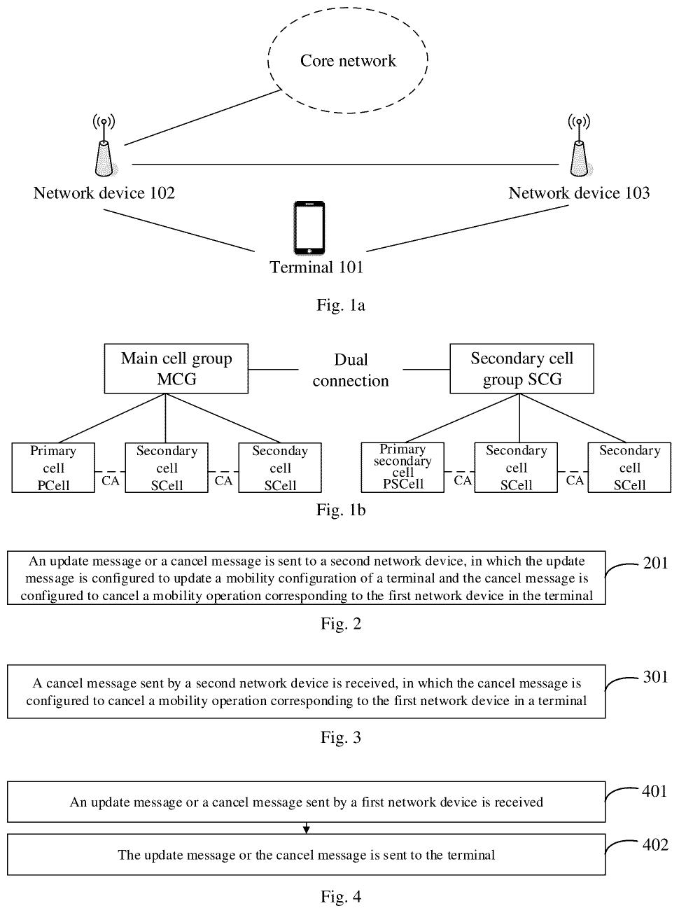

Referring to FIG. 2, FIG. 2 is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 2, the method may include, but is not limited to, the following steps.

In step 201, an update message or a cancel message is sent to a second network device, in which the update message is configured to update a mobility configuration of a terminal and the cancel message is configured to cancel a mobility operation corresponding to the first network device in the terminal.

In the embodiment of the present disclosure, the first network device is a network device to be activated. The network device to be activated refers to a network device corresponding to a cell or cell group to be activated.

In the embodiment of the present disclosure, the second network device is an anchor network device or a currently activated network device. The currently activated network device refers to a network device corresponding to a currently activated cell or cell group (the currently activated cell or cell group is also called a serving cell or cell group).

It may be understood that there is a radio interface connection between the currently activated network device and the terminal, and a radio interface message may be sent to the terminal, but there is no radio interface connection between the network device to be activated and the terminal.

In the embodiment of the present disclosure, the first network device (the network device to be activated) may send the update message or the cancel message to the anchor network device or the currently activated network device to update the mobility configuration of the terminal, or cancel the mobility operation corresponding to the first network device in the terminal.

In various embodiments of the present disclosure, the update message includes at least one of:
the mobility configuration updated by the first network device; a cell identifier corresponding to the updated mobility configuration; a cell group identifier corresponding to the updated mobility configuration; or a network device identifier corresponding to the updated mobility configuration.

In various embodiments of the present disclosure, the cancel message includes at least one of:
a cell identifier corresponding to the cancelled mobility operation; a cell group identifier corresponding to the cancelled mobility operation; or a network device identifier corresponding to the cancelled mobility operation.

It should be noted that in various embodiments of the present disclosure, two network devices may be connected through an Xn interface.

In some embodiments, the first network device (the network device to be activated) sends the update message or the cancel message to the anchor network device. There is a connection between the anchor network device and each device to be activated, and the anchor network device has a connection with the currently activated network device.

In the embodiment of the present disclosure, the anchor network device may be determined by a core network device or an initially activated network device. The anchor network device may be the initially activated network device, the currently activated network device or the network device to be activated, or other network devices not in the configuration.

In some embodiments, the update or cancel of the mobility configuration of the first network device may be initiated by the anchor network device, the currently activated network device or the first network device.

As a possible implementation, the anchor network device initiates the update of the mobility configuration of the first network device, and the first network device may receive an update request message sent by the anchor network device, and the update request message is configured to request the first network device to update the mobility configuration. After receiving the update request message, the first network device may send the update message to the anchor network device.

As another possible implementation, the currently activated network device initiates the update of the mobility configuration of the first network device, and the first network device may receive an update request message sent by the currently activated network device through the anchor network device. The update request message is configured to request the first network device to update the mobility configuration. After receiving the update request message, the first network device may send the update message to the currently activated network device through the anchor network device. That is, there may be no direct connection between the currently activated network device and the first network device, and the update request message and the update message need to be forwarded through the anchor network device.

It may be understood that the cancel of the mobility operation of the first network device may also be initiated by the anchor network device, and the related implementation is similar to the update of the mobility configuration, which is not repeated here.

In various embodiments of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

As another possible implementation, the first network device itself initiates the update or cancel of the mobility configuration of the first network device, and the first network device may send the update message or the cancel message to the anchor network device, so that the anchor network device may send the update message or the cancel message to the currently activated network device, and thus the currently activated network device may send the update message or the cancel message to the terminal, so as to complete the update or cancel of the mobility configuration.

In some embodiments, the anchor network device may also be changed. In response to a change of the anchor network device, the first network device may receive a first change notification message sent by an anchor network device before the change or an anchor network device after the change. The first change notification message is configured to notify that the anchor network device is changed.

In some embodiments, the first change notification message may include an identifier of the anchor network device after the change.

It may be understood that a source anchor network device before the change will be disconnected from the currently activated network device and each network device to be activated, while the anchor network device after the change will establish connections with the currently activated network device and each network device to be activated.

In some embodiments, the first network device (network device to be activated) sends the update message or the cancel message to the currently activated network device. The currently activated network device has a connection with each network device to be activated.

In some embodiments, the update or cancel of the mobility configuration of the first network device may be initiated by the currently activated network device or by the first network device itself.

As a possible implementation, the currently activated network device initiates the update of the mobility configuration of the first network device, and the first network device may receive an update request message sent by the currently activated network device. The update request message is configured to request the first network device to update the mobility configuration. After receiving the update request message, the first network device may send the update message to the currently activated network device.

As another possible implementation, the first network device itself initiates the update or cancel of the mobility configuration of the first network device, and the first network device may send the update message or the cancel message to the currently activated network device, so that the currently activated network device may send the update message or the cancel message to the terminal, so as to complete the update or cancel of the mobility configuration.

In some embodiments, in response to an absence of a mobility configuration related to the terminal in the first network device, the first network device may send a connection deleting message to the currently activated network device and other network devices to be activated, and the connection deleting message is configured to delete a connection between the currently activated network device and the first network device and a connection between other network devices to be activated and the first network device.

In some embodiments, the currently activated network device may also be changed, and in response to a change of the currently activated network device, a second change notification message sent by an activated network device before the change or an activated network device after the change is received. The second change notification message is configured to notify that the currently activated network device is changed.

In some embodiments, the second change notification message may include an identifier of the activated network device after the change.

In some embodiments, the first network device (the network device to be activated) sends the update message or the cancel message to the currently activated network device. The first network device may obtain a connection path between the currently activated network device and the first network device from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in a network device, either in the core network device or in an access network device.

In some embodiments, the update or cancel of the mobility configuration of the first network device may be initiated by the currently activated network device or by the first network device itself.

As a possible implementation, the currently activated network device initiates the update of the mobility configuration of the first network device, and the first network device may receive an update request message sent by the currently activated network device through the connection path, and the update request message is configured to request the first network device to update the mobility configuration. After receiving the update request message, the first network device may send the update message to the currently activated network device.

As another possible implementation, the first network device itself initiates the update or cancel of the mobility configuration of the first network device, and the first network device may send the update message or the cancel message to the currently activated network device through the connection path, so that the currently activated network device may send the update message or the cancel message to the terminal, so as to complete the update or cancel of the mobility configuration.

In some embodiments, in a case that no mobility configuration related to the terminal exists in the first network device, the first network device may send first indication information to a network device storing the node path table, and the first indication information is configured to instruct the network device storing the node path table to delete the first network device and a path connected to the first network device in the node path table.

In some embodiments, the currently activated network device may also be changed, and in response to a change of the currently activated network device, a second change notification message sent by an activated network device before the change or an activated network device after the change is received. The second change notification message is configured to notify that the currently activated network device is changed.

In some embodiments, the second change notification message may include an identifier of the activated network device after the change.

In some embodiments, the first network device (the network device to be activated) sends the update message or the cancel message to the currently activated network device. A connection path is arranged between the currently activated network device and the first network device.

In some embodiments, the update or cancel of the mobility configuration of the first network device may be initiated by the currently activated network device or by the first network device itself.

As a possible implementation, the currently activated network device initiates the update of the mobility configuration of the first network device, and the first network device may receive an update request message sent by the currently activated network device based on a network device adding the currently activated network device. The update request message is configured to request the first network device to update the mobility configuration. After receiving the update request message, the first network device may send an update message to the currently activated network device.

As another possible implementation, the first network device itself initiates the update or cancel of the mobility configuration of the first network device, and the first network device may send the update message or the cancel message to the currently activated network device based on a network device adding the first network device, so that the currently activated network device sends the update message or the cancel message to the terminal, so as to complete the update or cancel of the mobility configuration.

In some embodiments, the currently activated network device may also be changed. In response to a change of the currently activated network device, the first network device may receive a second change notification message sent by an activated network device before the change based on a network device to be activated that has a connection with the activated network device before the change. The second change notification message is configured to notify that the currently activated network device is changed.

In some embodiments, the second change notification message may include an identifier of an activated network device after the change.

In some implementations of the embodiments of the present disclosure, the first network device itself initiates the cancel of the mobility configuration of the first network device, and the first network device may also release resources reserved for the terminal, and/or release a context of the terminal stored in the first network device, in addition to sending the cancel message to the second network device.

In some embodiments, the reserved resources may include wireless resources, control plane resources, and the like.

In the embodiments of the present disclosure, one or more of the above update message, cancel message and update request message may further include first information. The first information is configured to explicitly or implicitly indicate that the above messages are suitable for selective activation of cells and/or cell groups. For example, the first information may be carried by the update message and the cancel message, and the first information is configured to indicate the update message and the cancel message explicitly.

In some embodiments, as an example, the first information may be 1-bit indication information, and is configured to explicitly indicate that a message related to the update or cancel is suitable for the selective activation of cells and/or cell groups. The first information may also be information unique to the selective activation of some cells and/or cell groups, and may implicitly indicate that the message related to the update or cancel is suitable for the selective activation of cells and/or cell groups.

To sum up, by sending the update message or the cancel message to the second network device, in which the update message is configured to update the mobility configuration of the terminal, and the cancel message is configured to cancel the mobility operation corresponding to the first network device in the terminal, the network device may cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

Referring to FIG. 3, FIG. 3 is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 3, the method may include, but is not limited to, the following steps.

In step 301, a cancel message sent by a second network device is received, in which the cancel message is configured to cancel a mobility operation corresponding to the first network device in a terminal.

In the embodiment of the present disclosure, the first network device is a network device to be activated. The network device to be activated refers to a network device corresponding to a cell or cell group to be activated.

In the embodiment of the present disclosure, the second network device is any one of an anchor network device and a currently activated network device. The currently activated network device refers to a network device corresponding to a currently activated cell or cell group (the currently activated cell or cell group is also called a serving cell or cell group).

It may be understood that there is a radio interface connection between the currently activated network device and the terminal, and a radio interface message may be sent to the terminal, but there is no radio interface connection between the network device to be activated and the terminal.

In the embodiment of the present disclosure, the first network device (the network device to be activated) may receive the cancel message sent by the anchor network device or the currently activated network device, to cancel the mobility operation corresponding to the first network device in the terminal.

In various embodiments of the present disclosure, the cancel message includes at least one of:
a cell identifier corresponding to the cancelled mobility operation; a cell group identifier corresponding to the cancelled mobility operation; or a network device identifier corresponding to the cancelled mobility operation.

It should be noted that in various embodiments of the present disclosure, two network devices may be connected through an Xn interface.

In some embodiments, the first network device (the network device to be activated) receives the cancel message sent by the anchor network device. There is a connection between the anchor network device and each device to be activated, and the anchor network device has a connection with the currently activated network device.

In the embodiment of the present disclosure, the anchor network device may be determined by a core network device or an initially activated network device. The anchor network device may be the initially activated network device, the currently activated network device or the network device to be activated, or other network devices not in the configuration.

In some embodiments, the cancel of the mobility configuration of the first network device may be initiated by the anchor network device or the currently activated network device.

As a possible implementation, the anchor network device initiates the cancel of the mobility configuration of the first network device, and the first network device may receive the cancel message sent by the anchor network device. After receiving the cancel message, the first network device may release resources reserved for the terminal and/or release a context of the terminal stored in the first network device according to the cancel message.

As another possible implementation, the currently activated network device initiates the cancel of the mobility configuration of the first network device, and the first network device may receive the cancel message sent by the currently activated network device through the anchor network device. After receiving the cancel message, the first network device may release resources reserved for the terminal and/or release a context of the terminal stored in the first network device according to the cancel message. That is, there may be no direct connection between the currently activated network device and the first network device, and the cancel message needs to be forwarded through the anchor network device.

In some embodiments, the anchor network device may also be changed. In response to a change of the anchor network device, the first network device may receive a first change notification message sent by an anchor network device before the change or an anchor network device after the change. The first change notification message is configured to notify that the anchor network device is changed.

In some embodiments, the first change notification message may include an identifier of the anchor network device after the change.

It may be understood that a source anchor network device before the change will be disconnected from the currently activated network device and each network device to be activated, while the anchor network device after the change will establish connections with the currently activated network device and each network device to be activated.

In some embodiments, the first network device (the network device to be activated) receives the cancel message sent by the currently activated network device. The currently activated network device has a connection with each network device to be activated.

As a possible implementation, the currently activated network device initiates the cancel of the mobility configuration of the first network device, and the first network device may receive the cancel message sent by the currently activated network device. After receiving the cancel message, the first network device may release resources reserved for the terminal and/or release a context of the terminal stored in the first network device according to the cancel message.

In some embodiments, in response to an absence of a mobility configuration related to the terminal in the first network device, the first network device may send a connection deleting message to the currently activated network device and other network devices to be activated, and the connection deleting message is configured to delete a connection between the currently activated network device and the first network device and a connection between other network devices to be activated and the first network device.

In some embodiments, the currently activated network device may also be changed, and in response to a change of the currently activated network device, a second change notification message sent by an activated network device before the change or an activated network device after the change is received. The second change notification message is configured to notify that the currently activated network device is changed.

In some embodiments, the second change notification message may include an identifier of the activated network device after the change.

In some embodiments, the first network device (the network device to be activated) receives the cancel message sent by the currently activated network device. The first network device and the currently activated network device may obtain a connection path between the currently activated network device and the first network device from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in a network device, either in a core network device or in an access network device.

As a possible implementation, the currently activated network device initiates the cancel of the mobility configuration of the first network device, and the first network device may receive the cancel message sent by the currently activated network device through the connection path. After receiving the cancel message, the first network device may release resources reserved for the terminal and/or release a context of the terminal stored in the first network device according to the cancel message.

In some embodiments, in a case that no mobility configuration related to the terminal exists in the first network device, the first network device may send first indication information to a network device storing the node path table, and the first indication information is configured to instruct the network device storing the node path table to delete the first network device and a path connected to the first network device in the node path table.

In some embodiments, the currently activated network device may also be changed, and in response to a change of the currently activated network device, a second change notification message sent by an activated network device before the change or an activated network device after the change is received. The second change notification message is configured to notify that the currently activated network device is changed.

In some embodiments, the second change notification message may include an identifier of the activated network device after the change.

In some embodiments, the first network device (the network device to be activated) receives the cancel message sent by the currently activated network device. A connection path is arranged between the currently activated network device and the first network device.

As a possible implementation, the currently activated network device initiates the cancel of the mobility configuration of the first network device, and the first network device may receive the cancel message sent by the currently activated network device based on a network device adding the currently activated network device. After receiving the cancel message, the first network device may release resources reserved for the terminal and/or release a context of the terminal stored in the first network device according to the cancel message.

In some embodiments, the currently activated network device may also be changed. In response to a change of the currently activated network device, the first network device may receive a second change notification message sent by an activated network device before the change based on a network device to be activated that has a connection with the activated network device before the change. The second change notification message is configured to notify that the currently activated network device is changed.

In some embodiments, the second change notification message may include an identifier of an activated network device after the change.

In some implementations of the embodiments of the present disclosure, the first network device itself initiates the cancel of the mobility configuration of the first network device, and the first network device may release resources reserved for the terminal, and/or release a context of the terminal stored in the first network device, in addition to sending the cancel message to the second network device.

Alternatively, the reserved resources may include wireless resources, control plane resources, and the like.

In the embodiment of the present disclosure, the cancel message may further include first information. The first information is configured to explicitly or implicitly indicate that the cancel message is suitable for selective activation of cells and/or cell groups.

In some embodiments, as an example, the first information may be 1-bit indication information, and is configured to explicitly indicate that a message related to the cancel is suitable for the selective activation of cells and/or cell groups. The first information may also be information unique to the selective activation of some cells and/or cell groups, and may implicitly indicate that the message related to the cancel is suitable for the selective activation of cells and/or cell groups.

To sum up, by receiving the cancel message sent by the second network device, in which the cancel message is configured to cancel the mobility operation corresponding to the first network device in the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

As shown in FIG. 4, FIG. 4 is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 4, the method may include, but is not limited to, the following steps.

In step 401, an update message or a cancel message sent by a first network device is received.

The currently activated network device refers to a network device corresponding to a currently activated cell or cell group (the currently activated cell or cell group is also called a serving cell or cell group).

In the embodiment of the present disclosure, the first network device is a network device to be activated. The network device to be activated refers to a network device corresponding to a cell or cell group to be activated.

It may be understood that there is a radio interface connection between the currently activated network device and the terminal, and a radio interface message may be sent to the terminal, but there is no radio interface connection between the network device to be activated and the terminal.

In the embodiment of the present disclosure, the currently activated network device may receive the update message or the cancel message sent by the first network device (the network device to be activated) to update a mobility configuration of the terminal, or cancel a mobility operation corresponding to the first network device in the terminal.

In various embodiments of the present disclosure, the update message includes at least one of:
the mobility configuration updated by the first network device; a cell identifier corresponding to the updated mobility configuration; a cell group identifier corresponding to the updated mobility configuration; and a network device identifier corresponding to the updated mobility configuration.

In various embodiments of the present disclosure, the cancel message includes at least one of:
a cell identifier corresponding to the cancelled mobility operation; a cell group identifier corresponding to the cancelled mobility operation; and a network device identifier corresponding to the cancelled mobility operation.

It should be noted that in various embodiments of the present disclosure, two network devices may be connected through an Xn interface.

In some embodiments, the currently activated network device may receive the update message or the cancel message sent by the first network device (the network device to be activated) through an anchor network device. There is a connection between the anchor network device and each device to be activated, and the anchor network device has a connection with the currently activated network device.

In the embodiment of the present disclosure, the anchor network device may be determined by a core network device or an initially activated network device. The anchor network device may be the initially activated network device, the currently activated network device or the network device to be activated, or other network devices not in the configuration.

In some embodiments, the update or cancel of the mobility configuration of the first network device may be initiated by the anchor network device, the currently activated network device or the first network device.

As a possible implementation, the anchor network device initiates the update of the mobility configuration of the first network device, and the currently activated network device may receive the update message sent by the anchor network device. The update message is sent to the anchor network device by the first network device after receiving an update request message sent by the anchor network device.

As another possible implementation, the currently activated network device initiates the update of the mobility configuration of the first network device, and the currently activated network device may send an update request message to the first network device through the anchor network device. The update request message is configured to request the first network device to update the mobility configuration. After receiving the update request message, the first network device may send the update message to the currently activated network device through the anchor network device, and the currently activated network device may receive the update message sent by the first network device through the anchor network device. That is, there may be no direct connection between the currently activated network device and the first network device, and the update request message and the update message need to be forwarded through the anchor network device.

In various embodiments of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

As another possible implementation, the first network device itself initiates the update or cancel of the mobility configuration of the first network device, and the currently activated network device may receive the update message or the cancel message sent by the first network device through the anchor network device, so that the currently activated network device may send the update message or the cancel message to the terminal, so as to complete the update or cancel of the mobility configuration.

In some embodiments, the anchor network device may also be changed. In response to a change of the anchor network device, the currently activated network device may also receive a first change notification message sent by an anchor network device before the change or an anchor network device after the change. The first change notification message is configured to notify that the anchor network device is changed.

In some embodiments, the first change notification message may include an identifier of the anchor network device after the change.

In some embodiments, the change of the anchor network device may be initiated by the anchor network device or by the currently activated network device. A source anchor network device before the change will be disconnected from the currently activated network device and each network device to be activated, while the anchor network device after the change will establish connections with the currently activated network device and each network device to be activated.

In some embodiments, the currently activated network device receives the update message or the cancel message sent by the first network device (the network device to be activated). The currently activated network device has a connection with each network device to be activated.

In some embodiments, the update or cancel of the mobility configuration of the first network device may be initiated by the currently activated network device or by the first network device itself.

As a possible implementation, the currently activated network device initiates the update of the mobility configuration of the first network device, and the currently activated network device may send an update request message to the first network device. The update request message is configured to request the first network device to update the mobility configuration. After receiving the update request message, the first network device may send the update message to the currently activated network device, and the currently activated network device receives the update message sent by the first network device.

As another possible implementation, the first network device itself initiates the update or cancel of the mobility configuration of the first network device, and the currently activated network device may receive the update message or cancel message sent by the first network device, so that the currently activated network device sends the update message or cancel message to the terminal, so as to complete the update or cancel of the mobility configuration.

In some embodiments, in response to an absence of a mobility configuration related to the terminal in the first network device, the currently activated network device may receive a connection deleting message sent by the first network device. The connection deleting message is configured to delete a connection between the currently activated network device and the first network device.

In some embodiments, the currently activated network device may also be changed, and in response to a change of the currently activated network device, a second change notification message may be sent to the first network device. The second change notification message is configured to notify that the currently activated network device is changed.

In some embodiments, the second change notification message may include an identifier of an activated network device after the change.

In some embodiments, the currently activated network device may also newly add a mobility configuration for the terminal, and this mobility configuration may be a new network device to be activated (called a target network device) that needs to be added correspondingly. The currently activated network device may send an adding request message to the target network device. The adding request message may include at least one of: an identifier of the currently activated network device, an identifier of the terminal, and an identifier of each existing network device to be activated. The currently activated network device may receive an adding request response message sent by the target network device. The adding request response message may include a mobility configuration of a cell or a cell group corresponding to the target network device. The currently activated network device may send the newly added mobility configuration to the terminal, which may include a configuration and a cell/cell group/network device corresponding to the configuration.

It may be understood that the target network device may also establish connections with the currently activated network device and each existing network device to be activated.

In some embodiments, the currently activated network device may receive a connection request message sent by the target network device, the connection request message may include indication information and/or a UE identifier, and the indication information is configured to indicate that the target network device is a network device to be activated for the UE, or to indicate that the target network device is an activated network device for the UE. The currently activated network device may also send a connection establishment response message to the target network device, and the connection establishment response message is configured to indicate that the connection establishment is successful.

Similarly, each existing network device to be activated may also receive a connection request message sent by the target network device and send a connection establishment response message to the target network device.

In some embodiments, the currently activated network device receives the update message or the cancel message sent by the first network device (the network device to be activated). The currently activated network device and the first network device may obtain a connection path between the currently activated network device and the first network device from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in a network device, either in a core network device or in an access network device.

In some embodiments, the update or cancel of the mobility configuration of the first network device may be initiated by the currently activated network device or by the first network device itself.

As a possible implementation, the currently activated network device initiates the update of the mobility configuration of the first network device, and the currently activated network device may send an update request message to the first network device through the connection path. The update request message is configured to request the first network device to update the mobility configuration. After receiving the update request message, the first network device may send the update message to the currently activated network device through the connection path, and the currently activated network device receives the update message sent by the first network device through the connection path.

As another possible implementation, the first network device itself initiates the update or cancel of the mobility configuration of the first network device, and the currently activated network device receives the update message or the cancel message sent by the first network device through the connection path, so that the currently activated network device sends the update message or the cancel message to the terminal, so as to complete the update or cancel of the mobility configuration.

In some embodiments, in a case that no mobility configuration related to the terminal exists in the first network device, the currently activated network device may also send first indication information to a network device storing the node path table. The first indication information is configured to instruct the network device storing the node path table to delete the first network device and a path connected to the first network device in the node path table.

In some embodiments, the currently activated network device may also be changed, and in response to a change of the currently activated network device, a second change notification message is sent to the first network device. The second change notification message is configured to notify that the currently activated network device is changed.

In some embodiments, the second change notification message may include an identifier of the activated network device after the change.

In some embodiments, the currently activated network device receives the update message or the cancel message sent by the first network device (the network device to be activated). A connection path is arranged between the currently activated network device and the first network device.

In some embodiments, the update or cancel of the mobility configuration of the first network device may be initiated by the currently activated network device or by the first network device itself.

As a possible implementation, the currently activated network device initiates the update of the mobility configuration of the first network device, and the currently activated network device may send an update request message to the first network device based on a network device adding the currently activated network device, and the update request message is configured to request the first network device to update the mobility configuration. After receiving the update request message, the first network device may send the update message to the currently activated network device based on a network device adding the first network device.

As another possible implementation, the first network device itself initiates the update or cancel of the mobility configuration of the first network device, and the currently activated network device may receive the update message or cancel message sent by the first network device based on a network device adding the first network device, so that the currently activated network device may send the update message or cancel message to the terminal, so as to complete the update or cancel of the mobility configuration.

In some embodiments, the currently activated network device may also be changed. In response to a change of the currently activated network device, an activated network device before the change may send a second change notification message to the first network device based on a network device to be activated that has a connection with the activated network device before the change. The second change notification message is configured to notify that the currently activated network device is changed.

In some embodiments, the second change notification message may include an identifier of an activated network device after the change.

In the embodiment of the present disclosure, the cancel message is configured for the first network device to release resources reserved for the terminal, and/or to release a context of the terminal stored in the first network device.

In some embodiments, the reserved resources may include wireless resources, control plane resources, and the like.

In the embodiment of the present disclosure, one or more of the above update message, cancel message and update request message may further include first information. The first information is configured to explicitly or implicitly indicate that the above messages are suitable for selective activation of cells and/or cell groups.

In some embodiments, as an example, the first information may be 1-bit indication information, and is configured to explicitly indicate that a message related to the update or cancel is suitable for the selective activation of cells and/or cell groups. The first information may also be information unique to the selective activation of some cells and/or cell groups, and may implicitly indicate that the message related to the update or cancel is suitable for the selective activation of cells and/or cell groups.

In some embodiments, the above adding request message, and/or the adding request response message, and/or the connection request message, and/or the connection establishment response message may also include the first information. The first information is configured to explicitly or implicitly indicate that the above messages are suitable for the selective activation of cells and/or cell groups.

In step 402, the update message or the cancel message is sent to the terminal.

The update message is configured to update a mobility configuration of the terminal, and the cancel message is configured to cancel a mobility operation corresponding to the first network device in the terminal.

In the embodiment of the present disclosure, there is a radio interface connection between the currently activated network device and the terminal, and the currently activated network device may sent the update message or the cancel message, which is sent by the first network device and is received by the currently activated network device, to the terminal. The terminal may update the mobility configuration of the terminal after receiving the update message, and may cancel the mobility operation corresponding to the first network device after receiving the cancel message.

To sum up, by receiving the update message or cancel message sent by the first network device and sending the update message or cancel message to the terminal, the network device may cancel the mobility operation or update the mobility configuration of the terminal through information interaction between nodes, so as to update the mobility configuration in time or cancel the inappropriate mobility operation, thus effectively improving the reliability of the mobility, enhancing the communication efficiency of the system and reducing the waste of resources.

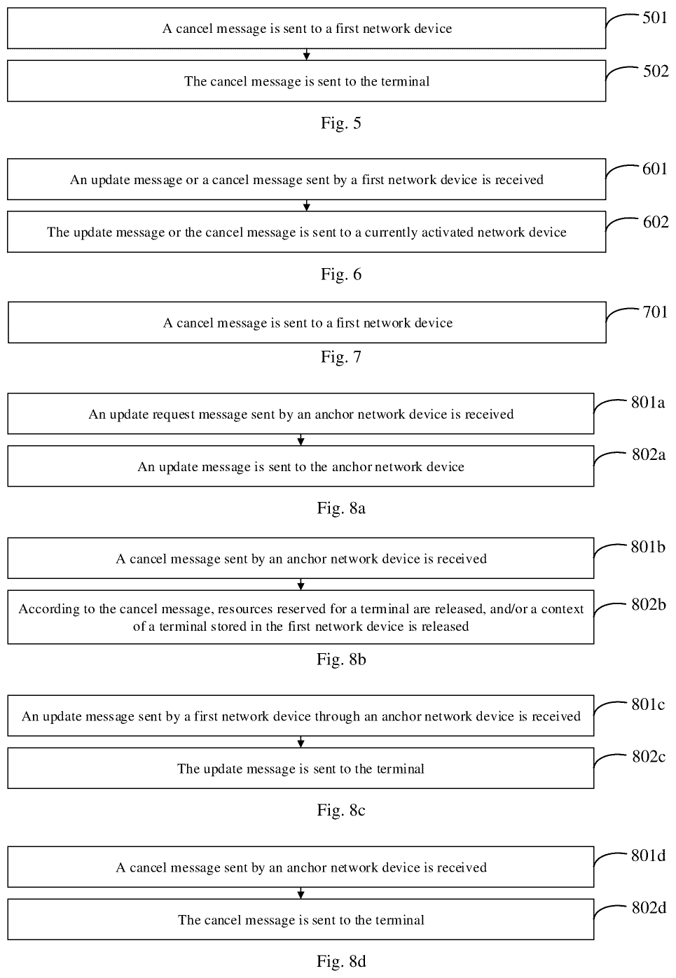

Referring to FIG. 5, FIG. 5 is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 5, the method may include, but is not limited to, the following steps.

In step 501, a cancel message is sent to a first network device.

The currently activated network device refers to a network device corresponding to a currently activated cell or cell group (the currently activated cell or cell group is also called a serving cell or cell group).

In the embodiment of the present disclosure, the first network device is a network device to be activated. The network device to be activated refers to a network device corresponding to a cell or cell group to be activated.

It may be understood that there is a radio interface connection between the currently activated network device and the terminal, and a radio interface message may be sent to the terminal, but there is no radio interface connection between the network device to be activated and the terminal.

In this embodiment, the currently activated network device may send the cancel message to the first network device (the network device to be activated) to cancel a mobility operation corresponding to the first network device in the terminal.

In various embodiments of the present disclosure, the cancel message includes at least one of:
a cell identifier corresponding to the cancelled mobility operation; a cell group identifier corresponding to the cancelled mobility operation; and a network device identifier corresponding to the cancelled mobility operation.

It should be noted that in various embodiments of the present disclosure, two network devices may be connected through an Xn interface.

In some embodiments, the currently activated network device may send the cancel message to the first network device (the network device to be activated) through an anchor network device. There is a connection between the anchor network device and each device to be activated, and the anchor network device has a connection with the currently activated network device.

In the embodiment of the present disclosure, the anchor network device may be determined by a core network device or an initially activated network device. The anchor network device may be the initially activated network device, the currently activated network device or the network device to be activated, or other network devices not in the configuration.

As a possible implementation, the currently activated network device initiates the cancel of the mobility configuration of the first network device, and the currently activated network device may send the cancel message to the first network device through the anchor network device. The cancel message is configured for the first network device to release resources reserved for the terminal and/or release a context of the terminal stored in the first network device. That is, there may be no direct connection between the currently activated network device and the first network device, and the cancel message needs to be forwarded through the anchor network device.

In some embodiments, the anchor network device may also be changed. In response to a change of the anchor network device, the currently activated network device may also receive a first change notification message sent by an anchor network device before the change or an anchor network device after the change. The first change notification message is configured to notify that the anchor network device is changed.

In some embodiments, the first change notification message may include an identifier of the anchor network device after the change.

In some embodiments, the change of the anchor network device may be initiated by the anchor network device or by the currently activated network device. A source anchor network device before the change will be disconnected from the currently activated network device and each network device to be activated, while the anchor network device after the change will establish connections with the currently activated network device and each network device to be activated.

In some embodiments, the currently activated network device sends the cancel message to the first network device (the network device to be activated). The currently activated network device has a connection with each network device to be activated.

As a possible implementation, the currently activated network device initiates the cancel of the mobility configuration of the first network device, and the currently activated network device may send the cancel message to the first network device. The cancel message is configured for the first network device to release resources reserved for the terminal and/or release a context of the terminal stored in the first network device.

In some embodiments, in response to an absence of a mobility configuration related to the terminal in the first network device, the currently activated network device may receive a connection deleting message sent by the first network device. The connection deleting message is configured to delete a connection between the currently activated network device and the first network device.

In some embodiments, the currently activated network device may also be changed, and in response to a change of the currently activated network device, a second change notification message may be sent to the first network device. The second change notification message is configured to notify that the currently activated network device is changed.

In some embodiments, the second change notification message may include an identifier of the activated network device after the change.

In some embodiments, the currently activated network device may also newly add a mobility configuration for the terminal, and this mobility configuration may be a new network device to be activated (called a target network device) that needs to be added correspondingly. The currently activated network device may send an adding request message to the target network device, and the adding request message may include at least one of: an identifier of the currently activated network device, an identifier of the terminal, and an identifier of each existing network device to be activated. The currently activated network device may receive an adding request response message sent by the target network device, and the adding request response message may include a mobility configuration of a cell or cell group corresponding to the target network device. The currently activated network device may send the newly added mobility configuration to the terminal, which may include a configuration and a cell/cell group/network device corresponding to the configuration.

It may be understood that the target network device may also establish connections with the currently activated network device and each existing network device to be activated.

In some embodiments, the currently activated network device may receive a connection request message sent by the target network device, the connection request message may include indication information and/or a UE identification, and the indication information is configured to indicate that the target network device is a network device to be activated for the UE, or to indicate that the target network device is an activated network device for the UE. The currently activated network device may also send a connection establishment response message to the target network device, and the connection establishment response message is configured to indicate that the connection establishment is successful.

Similarly, each existing network device to be activated may also receive a connection request message sent by the target network device and send a connection establishment response message to the target network device.

In some embodiments, the currently activated network device sends the cancel message to the first network device (the network device to be activated). The currently activated network device and the first network device may obtain a connection path between the currently activated network device and the first network device from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in the network device, either in a core network device or in an access network device.

As a possible implementation, the currently activated network device initiates the cancel of the mobility configuration of the first network device, and the currently activated network device may send the cancel message to the first network device through the connection path. The cancel message is configured for the first network device to release resources reserved for the terminal and/or release a context of the terminal stored in the first network device.

In some embodiments, in a case that no mobility configuration related to the terminal exists in the first network device, the currently activated network device may also send first indication information to a network device storing the node path table. The first indication information is configured to instruct the network device storing the node path table to delete the first network device and a path connected to the first network device in the node path table.

In some embodiments, the currently activated network device may also be changed, and in response to a change of the currently activated network device, a second change notification message is sent to the first network device. The second change notification message is configured to notify that the currently activated network device is changed.

In some embodiments, the second change notification message may include an identifier of the activated network device after the change.

In some embodiments, the currently activated network device receives an update message or a cancel message sent by the first network device (the network device to be activated). A connection path is arranged between the currently activated network device and the first network device.

As a possible implementation, the currently activated network device initiates the cancel of the mobility configuration of the first network device, and the currently activated network device may send the cancel message to the first network device based on a network device adding the currently activated network device. The cancel message is configured for the first network device to release resources reserved for the terminal and/or release a context of the terminal stored in the first network device.

In some embodiments, the currently activated network device may also be changed. In response to a change of the currently activated network device, an activated network device before the change may send a second change notification message to the first network device based on a network device to be activated that has a connection with the activated network device before the change. The second change notification message is configured to notify that the currently activated network device is changed.

In some embodiments, the second change notification message may include an identifier of the activated network device after the change.

In the embodiment of the present disclosure, the cancel message is configured for the first network device to release resources reserved for the terminal, and/or to release a context of the terminal stored in the first network device.

In some embodiments, the reserved resources may include wireless resources, control plane resources, and the like.

In the embodiment of the present disclosure, the cancel message may further include first information. The first information is configured to explicitly or implicitly indicate that the cancel message is suitable for selective activation of cells and/or cell groups.

In some embodiments, as an example, the first information may be 1-bit indication information, and is configured to explicitly indicate that a message related to the update or cancel is suitable for selective activation of cells and/or cell groups. The first information may also be information unique to the selective activation of some cells and/or cell groups, and may implicitly indicate that the message related to the update or cancel is suitable for the selective activation of cells and/or cell groups.

In some embodiments, the above adding request message, and/or adding request response message, and/or connection request message, and/or connection establishment response message may also include the first information, and the first information is configured to explicitly or implicitly indicate that the above messages are suitable for the selective activation of cells and/or cell groups.

In step 502, the cancel message is sent to the terminal.

The cancel message is configured to cancel a mobility operation corresponding to the first network device in the terminal.

In the embodiment of the present disclosure, there is a radio interface connection between the currently activated network device and the terminal, and the cancel message may be sent to the terminal. After receiving the cancel message, the terminal may cancel the mobility operation corresponding to the first network device.

To sum up, by sending the cancel message to the first network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

Referring to FIG. 6, FIG. 6 is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 6, the method may include, but is not limited to, the following steps.

In step 601, an update message or a cancel message sent by a first network device is received.

The update message is configured to update a mobility configuration of a terminal, and the cancel message is configured to cancel a mobility operation corresponding to the first network device in the terminal.

In various embodiments of the present disclosure, the update message includes at least one of:
the mobility configuration updated by the first network device; a cell identifier corresponding to the updated mobility configuration; a cell group identifier corresponding to the updated mobility configuration; and a network device identifier corresponding to the updated mobility configuration.

In various embodiments of the present disclosure, the cancel message includes at least one of:
a cell identifier corresponding to the cancelled mobility operation; a cell group identifier corresponding to the cancelled mobility operation; and a network device identifier corresponding to the cancelled mobility operation.

In the embodiment of the present disclosure, the first network device is a network device to be activated. The network device to be activated refers to a network device corresponding to a cell or cell group to be activated.

In the embodiment of the present disclosure, the currently activated network device refers to a network device corresponding to a currently activated cell or cell group (the currently activated cell or cell group is also called a serving cell or cell group).

It may be understood that there is a radio interface connection between the currently activated network device and the terminal, and a radio interface message may be sent to the terminal, but there is no radio interface connection between the network device to be activated and the terminal.

It should be noted that in various embodiments of the present disclosure, two network devices may be connected through an Xn interface.

In the embodiment of the present disclosure, the anchor network device may receive the update message or the cancel message sent by the first network device (the network device to be activated) to update the mobility configuration of the terminal, or cancel the mobility operation corresponding to the first network device in the terminal.

In the embodiment of the present disclosure, there is a connection between the anchor network device and each device to be activated, and the anchor network device has a connection with the currently activated network device. The anchor network device may be determined by a core network device or an initially activated network device. The anchor network device may be the initially activated network device, the currently activated network device or the network device to be activated, or other network devices not in the configuration.

In some embodiments, the update or cancel of a mobility configuration of the first network device may be initiated by the anchor network device, the currently activated network device or the first network device.

As a possible implementation, the anchor network device initiates the update of the mobility configuration of the first network device, and the anchor network device may send an update request message to the first network device. The update request message is configured to request the first network device to update the mobility configuration. After receiving the update request message, the first network device may send the update message to the anchor network device.

As another possible implementation, the currently activated network device initiates the update of the mobility configuration of the first network device, and the anchor network device may receive an update request message sent by the currently activated network device and forward the update request message to the first network device. The update request message is configured to request the first network device to update the mobility configuration. After receiving the update request message, the first network device may send the update message to the anchor network device, and the anchor network device forwards the update message to the currently activated network device.

In various embodiments of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

As another possible implementation, the first network device itself initiates the update or cancel of the mobility configuration of the first network device, the anchor network device may receive the update message or cancel message sent by the first network device, and then the anchor network device sends the update message or cancel message to the currently activated network device, so that the currently activated network device sends the update message or cancel message to the terminal, so as to complete the update or cancel of the mobility configuration.

In some embodiments, the anchor network device may also be changed. In response to a change of the anchor network device, the first network device may receive a first change notification message sent by an anchor network device before the change or an anchor network device after the change. The first change notification message is configured to notify that the anchor network device is changed.

In some embodiments, the first change notification message may include an identifier of the anchor network device after the change.

It may be understood that a source anchor network device before the change will be disconnected from the currently activated network device and each network device to be activated, while the anchor network device after the change will establish connections with the currently activated network device and each network device to be activated.

In the embodiment of the present disclosure, the cancel message is configured for the first network device to release resources reserved for the terminal, and/or to release a context of the terminal stored in the first network device.

In some embodiments, the reserved resources may include wireless resources, control plane resources, and the like.

In the embodiment of the present disclosure, one or more of the above update message, cancel message and update request message may further include first information. The first information is configured to explicitly or implicitly indicate that the above messages are suitable for selective activation of cells and/or cell groups. For example, the first information may be carried by the update message and the cancel message, and the first information is configured to explicitly indicate the update message and the cancel message.

In some embodiments, as an example, the first information may be 1-bit indication information, and is configured to explicitly indicate that a message related to the update or cancel is suitable for the selective activation of cells and/or cell groups. The first information may also be information unique to the selective activation of some cells and/or cell groups, and may implicitly indicate that the message related to the update or cancel is suitable for the selective activation of cells and/or cell groups.

In step 602, the update message or the cancel message is sent to a currently activated network device.

The currently activated network device is a network device corresponding to A currently activated cell or cell group.

In the embodiment of the present disclosure, after receiving the update message or the cancel message sent by the first network device, the anchor network device may send the update message or the cancel message to the currently activated network device.

To sum up, by receiving the update message or the cancel message sent by the first network device and sending the update message or the cancel message to the currently activated network device, the network device may cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system and reducing the waste of resources.

Referring to FIG. 7, FIG. 7 is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 7, the method may include, but is not limited to, the following steps.

In step 701, a cancel message is sent to a first network device.

The cancel message is configured to cancel a mobility operation corresponding to the first network device in a terminal.

In various embodiments of the present disclosure, the cancel message includes at least one of:
a cell identifier corresponding to the cancelled mobility operation; a cell group identifier corresponding to the cancelled mobility operation; and a network device identifier corresponding to the cancelled mobility operation.

In the embodiment of the present disclosure, the first network device is a network device to be activated. The network device to be activated refers to a network device corresponding to a cell or cell group to be activated.

In the embodiment of the present disclosure, a currently activated network device refers to a network device corresponding to a currently activated cell or cell group (the currently activated cell or cell group is also called a serving cell or cell group).

It may be understood that there is a radio interface connection between the currently activated network device and the terminal, and a radio interface message may be sent to the terminal, but there is no radio interface connection between the network device to be activated and the terminal.

It should be noted that in various embodiments of the present disclosure, two network devices may be connected through an Xn interface.

In the embodiment of the present disclosure, the anchor network device may receive an update message or the cancel message sent by the first network device (the network device to be activated) to update a mobility configuration of the terminal, or cancel the mobility operation corresponding to the first network device in the terminal.

In the embodiment of the present disclosure, there is a connection between the anchor network device and each device to be activated, and the anchor network device has a connection with the currently activated network device. The anchor network device may be determined by a core network device or an initially activated network device. The anchor network device may be an initially activated network device, the currently activated network device or the network device to be activated, or other network devices not in the configuration.

In some embodiments, the cancel of a mobility configuration of the first network device may be initiated by the anchor network device or the currently activated network device.

As a possible implementation, the anchor network device initiates the cancel of the mobility configuration of the first network device, and the anchor network device may send the cancel message to the first network device. The cancel message is configured for the first network device to release resources reserved for the terminal and/or release a context of the terminal stored in the first network device. The anchor network device may also send the cancel message to the currently activated network device, so that the currently activated network device may send the cancel message to the terminal, so as to complete the cancel of the corresponding mobility operation.

As another possible implementation, the currently activated network device initiates the cancel of the mobility configuration of the first network device, and the anchor network device may receive the cancel message sent by the currently activated network device and forward the cancel message to the first network device. The cancel message is configured for the first network device to release resources reserved for the terminal and/or release a context of the terminal stored in the first network device.

In some embodiments, the anchor network device may also be changed. In response to a change of the anchor network device, the first network device may receive a first change notification message sent by an anchor network device before the change or an anchor network device after the change. The first change notification message is configured to notify that the anchor network device is changed.

In some embodiments, the first change notification message may include an identifier of the anchor network device after the change.

It may be understood that a source anchor network device before the change will be disconnected from the currently activated network device and each network device to be activated, while the anchor network device after the change will establish connections with the currently activated network device and each network device to be activated.

In the embodiment of the present disclosure, the cancel message is configured for the first network device to release the resources reserved for the terminal, and/or to release the context of the terminal stored in the first network device.

In some embodiments, the reserved resources may include wireless resources, control plane resources, and the like.

In the embodiment of the present disclosure, the cancel message may further include first information. The first information is configured to explicitly or implicitly indicate that the cancel message is suitable for selective activation of cells and/or cell groups.

In some embodiments, as an example, the first information may be 1-bit indication information, and is used to explicitly indicate that a message related to the update or cancel is suitable for the selective activation of cells and/or cell groups. The first information may also be information unique to the selective activation of some cells and/or cell groups, and may implicitly indicate that the message related to the update or cancel is suitable for the selective activation of cells and/or cell groups.

To sum up, by sending the cancel message to the first network device, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

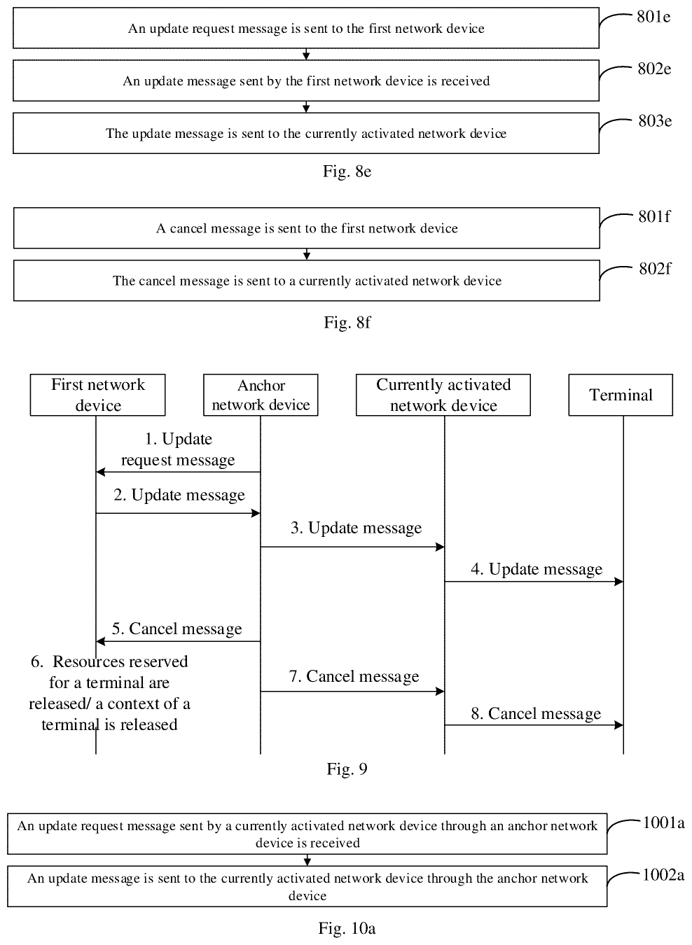

Referring to FIG. 8a, FIG. 8a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 8a, the method may include, but is not limited to, the following steps.

In step 801a, an update request message sent by an anchor network device is received.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 802a, an update message is sent to the anchor network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 801a to 802a may be respectively realized in any manner of the embodiments of the present disclosure, which is not limited in the embodiments of the present disclosure, and will not be repeated here.

To sum up, by receiving the update request message sent by the anchor network device and sending the update message to the anchor network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 8b, FIG. 8b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 8b, the method may include, but is not limited to, the following steps.

In step 801b, a cancel message sent by an anchor network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 802b, according to the cancel message, resources reserved for a terminal are released, and/or a context of a terminal stored in the first network device is released.

In some embodiments, the reserved resources may include wireless resources, control plane resources, and the like.

In the embodiment of the present disclosure, steps 801b to 802b may be respectively realized in any manner of the embodiments of the present disclosure, which is not limited in the embodiments of the present disclosure, and will not be repeated here.

To sum up, by receiving the cancel message sent by the anchor network device, the resources reserved for the terminal are released, and/or the context of the terminal stored in the first network device is released according to the cancel message, so that the network device may cancel the mobility operation of the terminal through information interaction between nodes, so as to cancel inappropriate mobility operations in time, thus effectively improving the reliability of mobility, enhancing the communication efficiency of the system and reducing the waste of resources.

Referring to FIG. 8c, FIG. 8c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 8c, the method may include, but is not limited to, the following steps.

In step 801c, an update message sent by a first network device through an anchor network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 802c, the update message is sent to the terminal.

The update message is sent to the terminal through a radio interface message, so as to complete the update of the mobility configuration.

In the embodiment of the present disclosure, steps 801c to 802c may be respectively realized in any manner of the embodiments of the present disclosure, which is not limited in the embodiments of the present disclosure, and will not be repeated here.

To sum up, by receiving the update message sent by the first network device through the anchor network device and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 8d, FIG. 8d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 8d, the method may include, but is not limited to, the following steps.

In step 801d, a cancel message sent by an anchor network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 802d, the cancel message is sent to the terminal.

The cancel message is sent to the terminal through a radio interface message, so as to complete the cancel of the mobility operation.

In the embodiment of the present disclosure, steps 801d to 802d may be realized in any manner of the embodiments of the present disclosure, which is not limited in the embodiments of the present disclosure, and will not be repeated here.

To sum up, by receiving the cancel message sent by the anchor network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

Referring to FIG. 8e, FIG. 8e is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 8e, the method may include, but is not limited to, the following steps.

In step 801e, an update request message is sent to the first network device.

In some embodiments, the update request message may include at least one of: a cell identifier corresponding to a mobility configuration requested to be updated; a cell group identifier corresponding to the mobility configuration requested to be updated; a network device identifier corresponding to the mobility configuration requested to be updated.

In step 802e, an update message sent by the first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 803e, the update message is sent to the currently activated network device.

In the embodiment of the present disclosure, steps 801e to 803e may be respectively realized in any manner of the embodiments of the present disclosure, which is not limited in the embodiments of the present disclosure, and will not be repeated here.

To sum up, by sending the update request message to the first network device, receiving the update message sent by the first network device, and sending the update message to the currently activated network device, the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 8f, FIG. 8f is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 8f, the method may include, but is not limited to, the following steps:

In step 801f, a cancel message is sent to the first network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 802f, the cancel message is sent to a currently activated network device.

In the embodiment of the present disclosure, steps 801f to 802f may be respectively realized in any manner of the embodiments of the present disclosure, which is not limited in the embodiments of the present disclosure, and will not be repeated here.

To sum up, by sending the cancel message to the first network device and sending the cancel message to the currently activated network device, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

It may be understood that the embodiments shown in FIGS. 8a, 8c and 8e are that the anchor network device initiates the update of the mobility configuration of the first network device, while the embodiments shown in FIGS. 8b, 8d and 8f are that the anchor network device initiates the cancel of the mobility configuration of the first network device. That is, the embodiments shown in FIGS. 8a-8f are scenarios in which, in a case that one anchor network device is determined, the anchor network device initiates the update or cancel of the mobility configuration of the first network device.

In order to better understand the mobility configuration methods in the scenarios shown in FIGS. 8a-8f, for example, reference may be made to FIG. 9, which is a flow chart of a mobility configuration method provided by an embodiment of the present disclosure. FIG. 9 includes an anchor network device, a currently activated network device, a first network device, and a terminal.
1. The anchor network device initiates an update of a mobility configuration on the first network device, and the anchor network device sends an update request message to the first network device.
2. After receiving the update request message, the first network device sends an update message to the anchor network device.
3. After receiving the update message, the anchor network device sends the update message to the currently activated network device.
4. After receiving the update message, the currently activated network device sends the update message to the terminal to update a corresponding mobility configuration.
5. The anchor network device initiates a cancel of the mobility configuration on the first network device, and the anchor network device sends a cancel message to the first network device.
6. After receiving the cancel message, the first network device releases resources reserved for the terminal, and/or releases a context of the terminal according to the cancel message.
7. The anchor network device sends the cancel message to the currently activated network device.
8. After receiving the cancel message, the currently activated network device sends the cancel message to the terminal to cancel a corresponding mobility operation.

It may be understood that the aforementioned steps 1-4 are intended to initiate the update of the mobility configuration, and steps 5-8 are intended to initiate the cancel of the mobility configuration. Steps 5-8 may be performed independently of steps 1-4, or part of steps 1-4 and part of steps 5-8 may be performed. Performing some or all of steps 1-4 and 5-8 is within the protection scope of the present disclosure. An execution sequence of steps 1-4 and 5-8 is not limited in this embodiment, for example, steps 5 and 7 may be executed at the same time, or step 5 is executed before step 7, or step 7 is executed before step 5, which is not limited in this embodiment. Any execution sequence and combination of any one or more of the above steps are within the protection scope of the present disclosure.

In the embodiment of the present disclosure, the anchor network device is selected by a network side, and may be determined by a core network device, an access network device, or an initially activated network device. The currently activated network device and each network device to be activated establish connections with the anchor network device. The anchor network device may be a network device for an initial cell group selective activation configuration or a network device determined by other networks. The anchor network device may be the network device to be activated or the currently activated network device, and the anchor network device may also be other network devices that are not in the cell group selective activation configuration.

In some embodiments, the anchor network device may be the network device to be activated or an activated network device, or the anchor network device may not be the network device to be activated or an activated network device.

In some embodiments, the currently activated network device may initiate the change of the anchor network device, and the anchor network device may also initiate the change of the anchor network device.

In some embodiments, the currently activated network device may initiate the change of the anchor network device, and the currently activated network device may send an anchor network device cancel message to a source anchor network device, and the source anchor network device is disconnected from the currently activated network device and each network device to be activated.

In some embodiments, the currently activated network device sends an anchor network device configuration message to a new anchor network device, and the new anchor network device establishes connections with the currently activated network device and each network device to be activated.

In some embodiments, the source anchor network device sends an anchor network device update message to the new anchor network device, and the source anchor network device is disconnected from the currently activated and each network device to be activated, and the new anchor network device establishes connections with the currently activated and each network device to be activated.

In some embodiments, in a case that the anchor network device is changed, the source anchor network device or the new anchor network device may send a first change notification message to the currently activated network device and each network device to be activated, and the first change notification message is configured to notify that the anchor network device is changed.

In some embodiments, the first change notification message may include an identifier of the anchor network device after the change.

In some embodiments, when a mobility operation occurs, in a case that the currently activated network device is changed, an activated network device before the change or an activated network device after the change needs to send a second change notification message to the anchor network device, and the second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In the embodiment of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

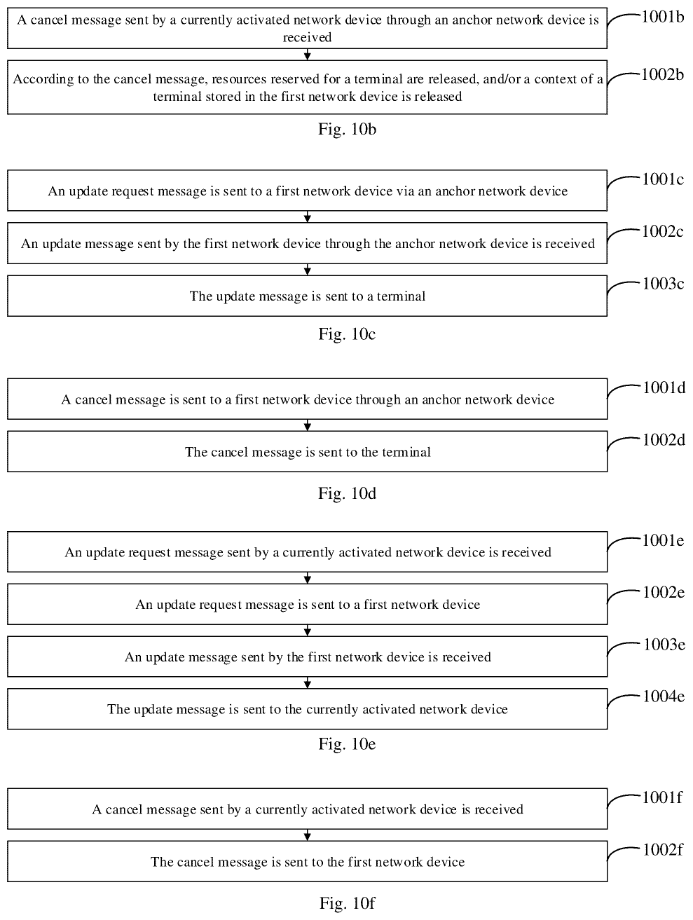

Referring to FIG. 10a, FIG. 10a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 10a, the method may include, but is not limited to, the following steps.

In step 1001a, an update request message sent by a currently activated network device through an anchor network device is received.

In some embodiments, the update request message may include at least one of: a cell identifier corresponding to a mobility configuration requested to be updated; a cell group identifier corresponding to the mobility configuration requested to be updated; and a network device corresponding to the mobility configuration requested to be updated.

In step 1002a, an update message is sent to the currently activated network device through the anchor network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 1001a to 1002a may be realized in any manner of the embodiments of the present disclosure, which is not limited in the embodiments of the present disclosure, and will not be repeated here.

To sum up, by receiving the update request message sent by the currently activated network device through the anchor network device and sending the update message to the currently activated network device through the anchor network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 10b, FIG. 10b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 10b, the method may include, but is not limited to, the following steps.

In step 1001b, a cancel message sent by a currently activated network device through an anchor network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1002b, according to the cancel message, resources reserved for a terminal are released, and/or a context of a terminal stored in the first network device is released.

In some embodiments, the reserved resources may include wireless resources, control plane resources, and the like.

In the embodiment of the present disclosure, steps 1001b to 1002b may be realized in any manner of the embodiments of the present disclosure, which is not limited in the embodiments of the present disclosure, and will not be repeated here.

To sum up, by receiving the cancel message sent by the currently activated network device through the anchor network device, the resources reserved for the terminal are released, and/or the context of the terminal stored in the first network device is released, according to the cancel message, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 10c, FIG. 10c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 10c, the method may include, but is not limited to, the following steps.

In step 1001c, an update request message is sent to a first network device via an anchor network device.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 1002c, an update message sent by the first network device through the anchor network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1003c, the update message is sent to a terminal.

The update message is sent to the terminal through a radio interface message to complete the update of the mobility configuration.

In the embodiment of the present disclosure, steps 1001c to 1003c may be respectively realized in any manner of the embodiments of the present disclosure, which is not limited in the embodiments of the present disclosure, and will not be repeated here.

To sum up, by sending the update request message to the first network device through the anchor network device, receiving the update message sent by the first network device through the anchor network device, and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 10d, FIG. 10d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 10d, the method may include, but is not limited to, the following steps.

In step 1001d, a cancel message is sent to a first network device through an anchor network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1002d, the cancel message is sent to the terminal.

The cancel message is sent to the terminal through a radio interface message to complete the cancel of the mobility operation.

In the embodiment of the present disclosure, steps 1001d to 1002d may be respectively realized in any manner of the embodiments of the present disclosure, which is not limited in the embodiments of the present disclosure, and will not be repeated here.

To sum up, by sending the cancel message to the first network device through the anchor network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

Referring to FIG. 10e, FIG. 10e is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 10e, the method may include, but is not limited to, the following steps.

In step 1001e, an update request message sent by a currently activated network device is received.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 1002e, an update request message is sent to a first network device.

In step 1003e, an update message sent by the first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1004e, the update message is sent to the currently activated network device.

In the embodiment of the present disclosure, steps 1001e to 1004e may be respectively realized in any manner of the embodiments of the present disclosure, which is not limited in the embodiments of the present disclosure, and will not be repeated here.

To sum up, by receiving the update request message sent by the currently activated network device, sending the update request message to the first network device, receiving the update message sent by the first network device, and sending the update message to the currently activated network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 10f, FIG. 10f is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 10f, the method may include, but is not limited to, the following steps.

In step 1001f, a cancel message sent by a currently activated network device is received.

In some embodiments, the cancel message includes at least one of:
a cell identifier corresponding to a cancelled mobility operation; a cell group identifier corresponding to a cancelled mobility operation; and a network device identifier corresponding to the cancelled mobility operation.

In step 1002f, the cancel message is sent to the first network device.

In the embodiment of the present disclosure, steps 1001f to 1002f may be respectively realized in any manner of the embodiments of the present disclosure, which will not be limited in the embodiments of the present disclosure, and will not be repeated here.

To sum up, by sending the cancel message to the first network device and sending the cancel message to the currently activated network device, the network device may cancel the mobility operation of the terminal through information interaction between nodes, and may cancel inappropriate mobility operations in time, thus effectively improving the reliability of mobility, enhancing the communication efficiency of the system and reducing the waste of resources.

It may be understood that the embodiments shown in FIGS. 10a, 10c and 10e are that the currently activated network device initiates the update of the mobility configuration of the first network device, while the embodiments shown in FIGS. 10b, 10d and 10f are that the currently activated network device initiates the cancel of the mobility configuration of the first network device. That is, the embodiments shown in FIGS. 10a-10f are scenarios in which, in a case that one anchor network device is determined, the currently activated network device initiates the update or cancel of the mobility configuration of the first network device.

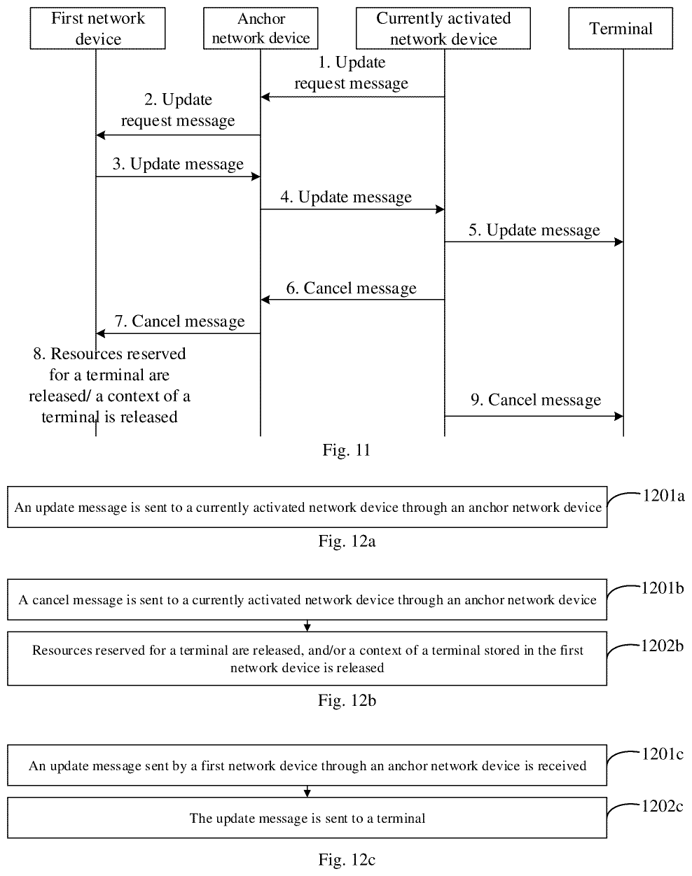

In order to better understand the mobility configuration methods in the scenarios shown in FIGS. 10a-10f, for example, reference may be made to FIG. 11, which is a flow chart of a mobility configuration method provided by an embodiment of the present disclosure. FIG. 11 shows an anchor network device, a currently activated network device, a first network device, and a terminal.
1. The currently activated network device initiates an update of a mobility configuration on the first network device, and the currently activated network device sends an update request message to the anchor network device.
2. After receiving the update request message, the anchor network device forwards the update request message to the first network device.
3. After receiving the update request message, the first network device sends the update message to the anchor network device.
4. After receiving the update message, the anchor network device sends the update message to the currently activated network device.
5. After receiving the update message, the currently activated network device sends the update message to the terminal to update a corresponding mobility configuration.
6. The currently activated network device initiates a cancel of the mobility configuration on the first network device, and the currently activated network device sends a cancel message to the anchor network device.
7. After receiving the cancel message, the anchor network device forwards the cancel message to the first network device.
8. After receiving the cancel message, the first network device releases resources reserved for the terminal, and/or releases a context of the terminal according to the cancel message.
9. The currently activated network device sends the cancel message to the terminal to cancel a corresponding mobility operation.

It may be understood that the aforementioned steps 1-5 are intended to initiate the update of the mobility configuration, and steps 6-9 are intended to initiate the cancel of the mobility configuration. Steps 6-9 may be performed independently of steps 1-5, or part of steps 1-5 and part of steps 6-9 may be performed. Performing some or all of steps of 1-5 and 6-9 is within the protection scope of the present disclosure. An execution sequence of steps 1-5 and 6-9 is not limited in this embodiment, for example, steps 6 and 9 may be executed at the same time, or step 6 is executed before step 9, or step 9 is executed before step 6, which is not limited in this embodiment. Any execution sequence and combination of any one or more of the above steps are within the protection scope of the present disclosure.

In the embodiment of the present disclosure, the anchor network device is selected by a network side, and may be determined by a core network device, an access network device or an initially activated network device. The currently activated network device and each network device to be activated establish connections with the anchor network device. The anchor network device may be a network device for an initial cell group selective activation configuration or a network device determined by other networks. The anchor network device may be the network device to be activated or the currently activated network device, and the anchor network device may also be other network devices that are not in the cell group selective activation configuration.

In some embodiments, the anchor network device may be the network device to be activated or an activated network device, and the anchor network device may not be the network device to be activated or an activated network device.

In some embodiments, the currently activated network device may initiate the change of the anchor network device, and the anchor network device may also initiate the change of the anchor network device.

In some embodiments, the currently activated network device may initiate the change of the anchor network device, and the currently activated network device may send an anchor network device cancel message to a source anchor network device, and the source anchor network device is disconnected from the currently activated network device and each network device to be activated. The currently activated network device sends an anchor network device configuration message to a new anchor network device, and the new anchor network device establishes connections with the currently activated and each network device to be activated.

In some embodiments, the source anchor network device sends an anchor network device update message to a new anchor network device, a source anchor network device is disconnected from the currently activated network device and each network device to be activated, and the new anchor network device establishes connections with the currently activated network device and each network device to be activated.

In some embodiments, in a case that the anchor network device is changed, a source anchor network device or a new anchor network device may send a first change notification message to the currently activated network device and each network device to be activated, and the first change notification message is configured to notify that the anchor network device is changed.

In some embodiments, the first change notification message may include an identifier of the anchor network device after the change.

In some embodiments, when a mobility operation occurs, in a case that the currently activated network device is changed, an activated network device before the change or an activated network device after the change needs to send a second change notification message to the anchor network device, and the second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In the embodiment of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

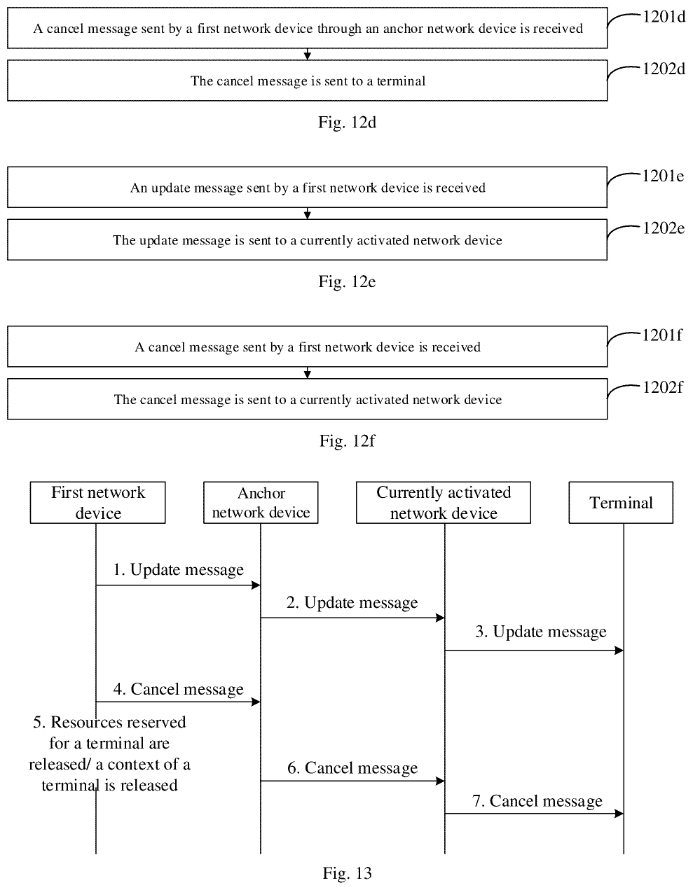

Referring to FIG. 12a, FIG. 12a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 12a, the method may include, but is not limited to, the following steps.

In step 1201a, an update message is sent to a currently activated network device through an anchor network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, step 1201a may be realized in any manner of the embodiments of the present disclosure, which is not limited in the embodiments of the present disclosure, and will not be repeated here.

To sum up, by sending the update message to the currently activated network device through the anchor network device, the network device may update the mobility configuration of the terminal through information interaction between nodes, so as to update the mobility configuration in time, thus effectively improving the reliability of mobility, enhancing the communication efficiency of the system and reducing the waste of resources.

As shown in FIG. 12b, FIG. 12b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 12b, the method may include, but is not limited to, the following steps.

In step 1201b, a cancel message is sent to a currently activated network device through an anchor network device.

In some embodiments, the cancel message includes at least one of:
a cell identifier corresponding to a cancelled mobility operation; a cell group identifier corresponding to a cancelled mobility operation; and a network device identifier corresponding to the cancelled mobility operation.

In step 1202b, resources reserved for a terminal are released, and/or a context of a terminal stored in the first network device is released.

In some embodiments, the reserved resources may include wireless resources, control plane resources, and the like.

In the embodiment of the present disclosure, steps 1201b to 1202b may be realized in any manner of the embodiments of the present disclosure, which is not limited in the embodiments of the present disclosure, and will not be repeated here.

To sum up, by sending the cancel message to the currently activated network device through the anchor network device, the resources reserved for the terminal are released, and/or the context of the terminal stored in the first network device is released, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 12c, FIG. 12c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 12c, the method may include, but is not limited to, the following steps.

In step 1201c, an update message sent by a first network device through an anchor network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1202c, the update message is sent to a terminal.

The update message is sent to the terminal through a radio interface message to complete the update of the mobility configuration.

In the embodiment of the present disclosure, steps 1201c to 1202c may be realized in any manner of the embodiments of the present disclosure, which is not limited in the embodiments of the present disclosure, and will not be repeated here.

To sum up, by receiving the update message sent by the first network device through the anchor network device and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 12d, FIG. 12d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 12d, the method may include, but is not limited to, the following steps.

In step 1201d, a cancel message sent by a first network device through an anchor network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1202d, the cancel message is sent to a terminal.

The cancel message is sent to the terminal through a radio interface message to complete the cancel of the mobility operation.

In the embodiment of the present disclosure, steps 1201d to 1202d may be respectively realized in any manner of the embodiments of the present disclosure, which is not limited in the embodiments of the present disclosure, and will not be repeated here.

To sum up, by receiving the cancel message sent by the first network device through the anchor network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

Referring to FIG. 12e, FIG. 12e is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 12e, the method may include, but is not limited to, the following steps.

In step 1201e, an update message sent by a first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1202e, the update message is sent to a currently activated network device.

In the embodiment of the present disclosure, steps 1201e to 1202e may be respectively realized in any manner of the embodiments of the present disclosure, which is not limited in the embodiments of the present disclosure, and will not be repeated here.

To sum up, by receiving an update request message sent by the currently activated network device, sending the update request message to the first network device, receiving the update message sent by the first network device, and sending the update message to the currently activated network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 12f, FIG. 12f is a flow chart of a mobility configuration method provided by an embodiment of the present disclosure. It should be noted that the mobility configuration method of the embodiment of the present disclosure is performed by an anchor network device. The method may be performed independently or in combination with any other embodiment of the present disclosure. As shown in FIG. 12f, the method may include, but is not limited to, the following steps.

In step 1201f, a cancel message sent by a first network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1202f, the cancel message is sent to a currently activated network device.

In the embodiment of the present disclosure, steps 1201f to 1202f may be respectively realized in any manner of the embodiments of the present disclosure, which is not limited in the embodiments of the present disclosure, and will not be repeated here.

To sum up, by sending the cancel message to the first network device and sending the cancel message to the currently activated network device, the network device may cancel the mobility operation of the terminal through information interaction between nodes, so as to cancel inappropriate mobility operations in time, effectively improving the reliability of mobility, enhancing the communication efficiency of the system and reducing the waste of resources.

It may be understood that the embodiments shown in FIGS. 12a, 12c and 12e are that the currently activated network device initiates the update of the mobility configuration of the first network device, while the embodiments shown in FIGS. 12b, 12d and 12f are that the currently activated network device initiates the cancel of the mobility configuration of the first network device. That is, the embodiments shown in FIGS. 12a-12f are scenarios in which, in a case that one anchor network device is determined, the currently activated network device initiates the update or cancel of the mobility configuration of the first network device.

In order to better understand the mobility configuration methods in the scenarios shown in FIGS. 12a-12f, for example, reference may be made to FIG. 13, which is a flow chart of a mobility configuration method provided by an embodiment of the present disclosure. FIG. 13 shows an anchor network device, a currently activated network device, a first network device, and a terminal.
1. The first network device initiates an update of a mobility configuration on the first network device, and the first network device sends an update message to the anchor network device.
2. After receiving the update message, the anchor network device sends the update message to the currently activated network device.
3. After receiving the update message, the currently activated network device sends the update message to the terminal to update a corresponding mobility configuration.
4. The first network device initiates a cancel of the mobility configuration on the first network device, and the first network device sends a cancel message to the anchor network device.
5. The first network device releases resources reserved for the terminal, and/or releases a context of the terminal.
6. After receiving the cancel message, the anchor network device forwards the cancel message to the currently activated network device.
7. The currently activated network device sends the cancel message to the terminal to cancel a corresponding mobility operation.

It may be understood that the aforementioned steps 1-3 are intended to initiate the update of the mobility configuration, and steps 4-7 are intended to initiate the cancel of the mobility configuration. Steps 4-7 may be performed independently of steps 1-3, or part of steps 1-3 and part of steps 4-7 may be performed. Performing some or all of steps 1-3 and 4-7 are within the protection scope of the present disclosure. An execution sequence of steps 1-3 and 4-7 is not limited in this embodiment. Any execution sequence and combination of any one or more of the above steps are within the protection scope of the present disclosure.

In the embodiment of the present disclosure, the anchor network device is selected by a network side, and may be determined by a core network device, an access network device or an initially activated network device. The currently activated network device and each network device to be activated establish connections with the anchor network device. The anchor network device may be a network device for an initial cell group selective activation configuration or a network device determined by other networks. The anchor network device may be the network device to be activated or the currently activated network device, and the anchor network device may also be other network devices that are not in the cell group selective activation configuration.

In some embodiments, the currently activated network device may initiate the change of the anchor network device, and the anchor network device may also initiate the change of the anchor network device.

In some embodiments, the currently activated network device may initiate the change of the anchor network device, and the currently activated network device may send an anchor network device cancel message to a source anchor network device, and the source anchor network device is disconnected from the currently activated network device and each network device to be activated. The currently activated network device sends an anchor network device configuration message to a new anchor network device, and the new anchor network device establishes connections with the currently activated and each network device to be activated.

In some embodiments, a source anchor network device sends an anchor network device update message to a new anchor network device, and the source anchor network device is disconnected from the currently activated network device and each network device to be activated, and the new anchor network device establishes connections with the currently activated and each network device to be activated.

In some embodiments, in a case that the anchor network device is changed, a source anchor network device or a new anchor network device may send a first change notification message to the currently activated network device and each network device to be activated, and the first change notification message is configured to notify that the anchor network device is changed.

In some embodiments, the first change notification message may include an identifier of the anchor network device after the change.

In some embodiments, when a mobility operation occurs, in a case that the currently activated network device is changed, an activated network device before the change or an activated network device after the change needs to send a second change notification message to the anchor network device, and the second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

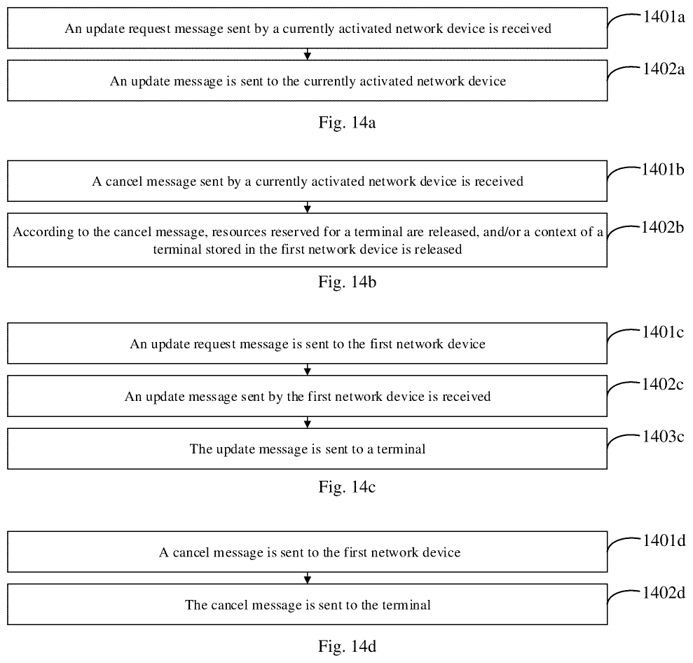

Referring to FIG. 14a, FIG. 14a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 14a, the method may include, but is not limited to, the following steps.

In step 1401a, an update request message sent by a currently activated network device is received.

In step 1402a, an update message is sent to the currently activated network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 1401a to 1402a may be realized in any manner of the embodiments of the present disclosure, which is not limited in the embodiments of the present disclosure, and will not be repeated here.

To sum up, by receiving the update request message sent by the currently activated network device and sending the update message to the currently activated network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 14b, FIG. 14b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 14b, the method may include, but is not limited to, the following steps.

In step 1401b, a cancel message sent by a currently activated network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1402b, according to the cancel message, resources reserved for a terminal are released, and/or a context of a terminal stored in the first network device is released.

In some embodiments, the reserved resources may include wireless resources, control plane resources, and the like.

In the embodiment of the present disclosure, steps 1401b to 1402b may be realized in any manner of the embodiments of the present disclosure, which is not limited in the embodiments of the present disclosure, and will not be repeated here.

To sum up, by receiving the cancel message sent by the currently activated network device, and releasing the resources reserved for the terminal and/or the context of the terminal stored in the first network device according to the cancel message, the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 14c, FIG. 14c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 14c, the method may include, but is not limited to, the following steps.

In step 1401c, an update request message is sent to the first network device.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 1402c, an update message sent by the first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1403c, the update message is sent to a terminal.

The update message is sent to the terminal through a radio interface message to complete the update of the mobility configuration.

In the embodiment of the present disclosure, steps 1401c to 1403c may be respectively realized in any manner of the embodiments of the present disclosure, which is not limited in the embodiments of the present disclosure, and will not be repeated here.

To sum up, by sending the update request message to the first network device, receiving the update message sent by the first network device, and sending the update message to the terminal, the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 14d, FIG. 14d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 14d, the method may include, but is not limited to, the following steps.

In step 1401d, a cancel message is sent to the first network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1402d, the cancel message is sent to the terminal.

The cancel message is sent to the terminal through a radio interface message to complete the cancel of the mobility operation.

In the embodiment of the present disclosure, steps 1401d to 1402d may be respectively realized in any manner of the embodiments of the present disclosure, which is not limited in the embodiments of the present disclosure, and will not be repeated here.

To sum up, by sending the cancel message to the first network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

It may be understood that the embodiments shown in FIGS. 14a and 14c are that the currently activated network device initiates the update of the mobility configuration of the first network device, while the embodiments shown in FIGS. 14b and 14d are that the currently activated network device initiates the cancel of the mobility configuration of the first network device. That is, the embodiments shown in FIGS. 14a-14d are scenarios in which, in a case that one anchor network device is determined, the currently activated network device initiates the update or cancel of the mobility configuration of the first network device.

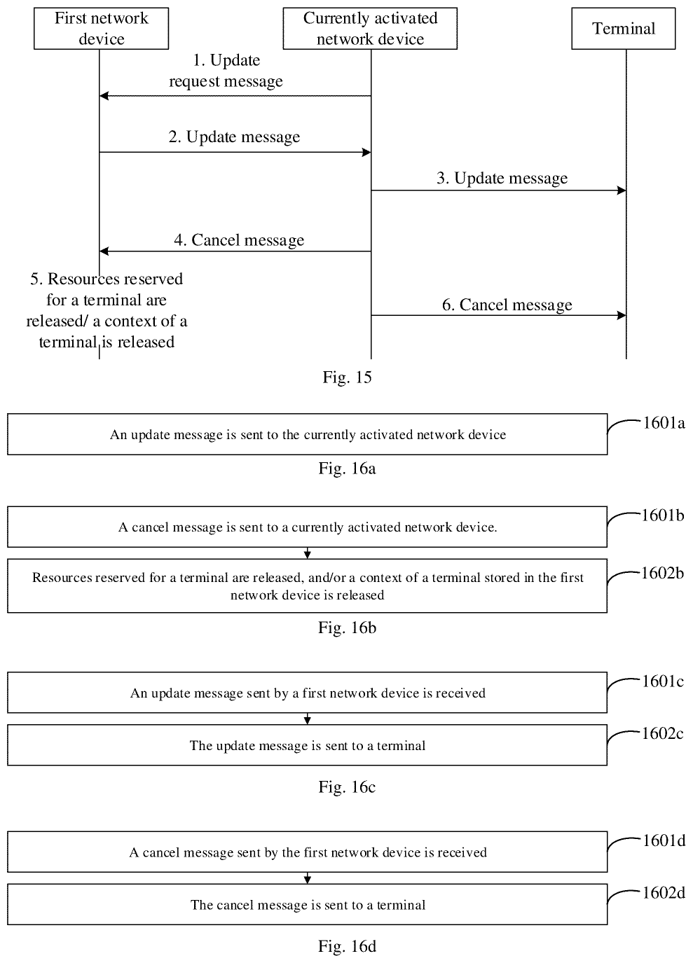

In order to better understand the mobility configuration methods in the scenarios shown in FIGS. 14a-14d, for example, reference may be made to FIG. 15, which is a flow chart of a mobility configuration method provided by an embodiment of the present disclosure. FIG. 15 shows a currently activated network device, a first network device, and a terminal.
1. The currently activated network device initiates an update of a mobility configuration on the first network device, and the currently activated network device sends an update request message to the first network device.
2. After receiving the update request message, the first network device sends an update message to the currently activated network device.
3. After receiving the update message, the currently activated network device sends the update message to the terminal to update a corresponding mobility configuration.
4. The currently activated network device initiates a cancel of the mobility configuration on the first network device, and the currently activated network device sends a cancel message to the first network device.
5. After receiving the cancel message, the first network device releases resources reserved for the terminal, and/or releases a context of the terminal according to the cancel message.
6. The currently activated network device sends the cancel message to the terminal to cancel a corresponding mobility operation.

It may be understood that the aforementioned steps 1-3 are intended to initiate the update of the mobility configuration, and steps 4-6 are intended to initiate the cancel of the mobility configuration. Steps 4-6 may be performed independently of steps 1-3, or part of steps 1-3 and part of steps 4-6 may be performed. Performing some or all of steps 1-3 and 4-6 is within the protection scope of the present disclosure. An execution sequence of steps 1-3 and 4-6 is not limited in this embodiment, for example, steps 4 and 6 may be executed at the same time, or step 4 is executed before step 6, or step 6 is executed before step 4, which is not limited in this embodiment. Any execution sequence and combination of any one or more of the above steps are within the protection scope of the present disclosure.

In the embodiment of the present disclosure, the currently activated network device has a connection with each network device to be activated.

In some embodiments, the currently activated network device may newly add a mobility configuration to the terminal. In a case that a target network device corresponding to this newly added mobility configuration is not a currently existing network device to be activated, the target network device corresponding to this configuration needs to establish connections with the currently activated network device and all the current network devices to be activated, which includes one or more of the following steps (not shown in the drawings).
1.1 The currently activated network device sends an adding request message to the target network device.
1.2 The target network device sends an adding request response message to the currently activated network device.
1.3 The target network device sends a connection request message to the currently activated network device and each network device to be activated, for requesting to establish a connection.
1.4 The currently activated network device and each network device to be activated send a connection establishment response message to the target network device.
1.5 The currently activated network device may send the newly added mobility configuration to the terminal, which may include the mobility configuration and a cell/cell group/network device corresponding to the configuration.

The addition request message may include at least one of: an identifier of the currently activated network device, an identifier of the terminal, and an identifier of each existing network device to be activated.

The adding request response message may include a mobility configuration of a cell or a cell group corresponding to the target network device.

The connection request message may include indication information and/or a UE identifier, the indication information is configured to indicate that the target network device is a network device to be activated for the UE, or to indicate that the target network device is an activated network device for the UE.

The connection establishment response message is configured to indicate that the connection establishment is successful.

In some embodiments, when a mobility operation occurs, in a case that the currently activated network device is changed, an activated network device before the change or an activated network device after the change needs to send a second change notification message to each network device to be activated. The second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In the embodiment of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In some embodiments, in response to an absence of a mobility configuration related to the terminal in the first network device, the first network device may send a connection deleting message to the currently activated network device and/or other network devices to be activated, and the connection deleting message is configured to delete a connection between the currently activated network device and the first network device and/or a connection between other network devices to be activated and the first network device.

In some embodiments, in response to an absence of a mobility configuration related to the terminal in the first network device, the currently activated network device may also send a connection cancelling request message to other network devices to be activated, and the connection cancelling request message is configured to instruct other network devices to be activated to delete a connection with the first network device.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

Referring to FIG. 16a, FIG. 16a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 16a, the method may include, but is not limited to, the following steps.

In step 1601a, an update message is sent to the currently activated network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, step 1601a may be realized in any manner of the embodiments of the present disclosure, which is not limited in the embodiments of the present disclosure, and will not be repeated here.

To sum up, by sending the update message to the currently activated network device, the network device may update the mobility configuration of a terminal through information interaction between nodes, so as to update the mobility configuration in time, thus effectively improving the reliability of mobility, enhancing the communication efficiency of the system and reducing the waste of resources.

Referring to FIG. 16b, FIG. 16b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 16b, the method may include, but is not limited to, the following steps:

In step 1601b, a cancel message is sent to a currently activated network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1602b, resources reserved for a terminal are released, and/or a context of a terminal stored in the first network device is released.

In some embodiments, the reserved resources may include wireless resources, control plane resources, and the like.

In the embodiment of the present disclosure, steps 1601b to 1602b may be respectively realized in any manner of the embodiments of the present disclosure, which is not limited in the embodiments of the present disclosure, and will not be repeated here.

To sum up, by sending the cancel message to the currently activated network device, the resources reserved for the terminal are released, and/or the context of the terminal stored in the first network device is released, so that the network device may cancel the mobility operation of the terminal through information interaction between nodes, so as to cancel inappropriate mobility operation ins time, thus effectively improving the reliability of mobility, enhancing the communication efficiency of the system and reducing the waste of resources.

Referring to FIG. 16c, FIG. 16c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 16c, the method may include, but is not limited to, the following steps.

In step 1601c, an update message sent by a first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1602c, the update message is sent to a terminal.

The update message is sent to the terminal through a radio interface message to complete the update of the mobility configuration.

In the embodiment of the present disclosure, steps 1601c to 1602c may be realized in any manner of the embodiments of the present disclosure, which is not limited in the embodiments of the present disclosure, and will not be repeated here.

To sum up, by receiving the update message sent by the first network device and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 16d, FIG. 16d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 16d, the method may include, but is not limited to, the following steps.

In step 1601d, a cancel message sent by the first network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1602d, the cancel message is sent to a terminal.

The cancel message is sent to the terminal through a radio interface message to complete the cancel of the mobility operation.

In the embodiment of the present disclosure, steps 1601d to 1602d may be respectively realized in any manner of the embodiments of the present disclosure, which is not limited in the embodiments of the present disclosure, and will not be repeated here.

To sum up, by receiving the cancel message sent by the first network device and sending the cancel message to the terminal, the network device may cancel the mobility operation of the terminal through information interaction between nodes, so as to cancel inappropriate mobility operations in time, thus effectively improving the reliability of mobility, enhancing the communication efficiency of the system and reducing the waste of resources.

It may be understood that the embodiments shown in FIGS. 16a and 16c are that the currently activated network device initiates the update of the mobility configuration of the first network device, while the embodiments shown in FIGS. 16b and 16d are that the currently activated network device initiates the cancel of the mobility configuration of the first network device. That is, the embodiments shown in FIGS. 16a-16d are scenarios in which, in a case that one anchor network device is determined, the currently activated network device initiates the update or cancel of the mobility configuration of the first network device.

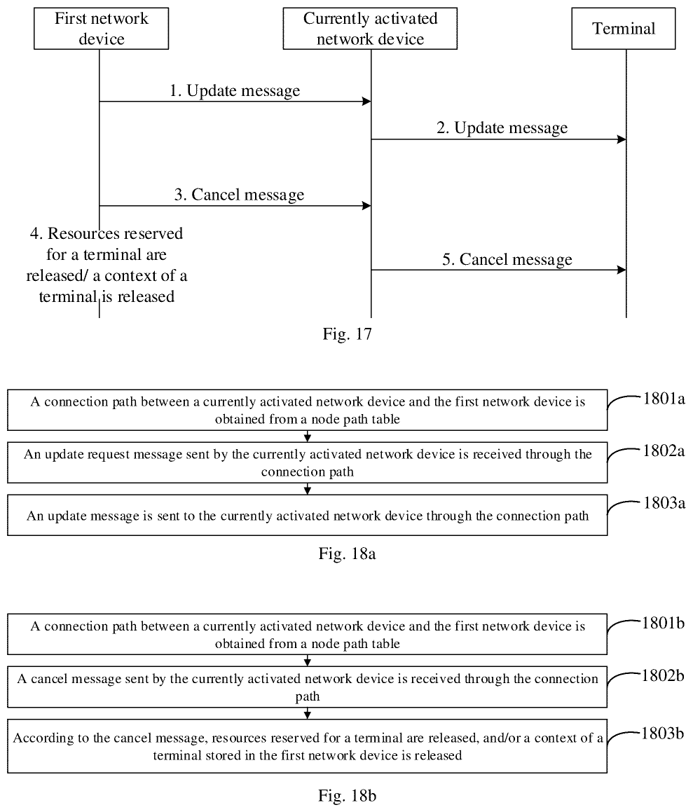

In order to better understand the mobility configuration methods in the scenarios shown in FIGS. 16a-16d, for example, reference may be made to FIG. 17, which is a flow chart of a mobility configuration method provided by an embodiment of the present disclosure. FIG. 17 shows a currently activated network device, a first network device, and a terminal.
1. The first network device initiates an update of a mobility configuration on the first network device, and the first network device sends an update message to the currently activated network device.
2. After receiving the update message, the currently activated network device sends the update message to the terminal to update a corresponding mobility configuration.
3. The first network device initiates a cancel of the mobility configuration on the first network device, and the first network device sends a cancel message to the currently activated network device.
4. The first network device releases resources reserved for the terminal, and/or releases a context of the terminal.
5. The currently activated network device sends the cancel message to the terminal to cancel a corresponding mobility operation.

It may be understood that the aforementioned steps 1-2 are intended to initiate the update of the mobility configuration, and steps 3-5 are intended to initiate the cancel of the mobility configuration. Steps 3-5 may be performed independently of steps 1-2, and part of steps 1-2 and part of steps 3-5 may also be performed. Performing some or all of steps of 1-2 and 3-5 are within the protection scope of the present disclosure. An execution sequence of steps 1-2 and 3-5 is not limited in this embodiment. Any execution sequence and combination of any one or more of the above steps are within the protection scope of the present disclosure.

In the embodiment of the present disclosure, the currently activated network device has a connection with each network device to be activated.

In some embodiments, the currently activated network device may newly add a mobility configuration to the terminal. In a case that a target network device corresponding to this newly added mobility configuration is not a currently existing network device to be activated, the target network device corresponding to this configuration needs to establish connections with the currently activated network device and all the current network devices to be activated, which includes one or more of the following steps (not shown in the drawings).
1.1 The currently activated network device sends an adding request message to the target network device.
1.2 The target network device sends an adding request response message to the currently activated network device.
1.3 The target network device sends a connection request message to the currently activated network device and each network device to be activated, for requesting to establish a connection.
1.4 The currently activated network device and each network device to be activated send a connection establishment response message to the target network device.
1.5 The currently activated network device may send the newly added mobility configuration to the terminal, which may include the mobility configuration and a cell/cell group/network device corresponding to the configuration.

The addition request message may include at least one of: an identifier of the currently activated network device, an identifier of the terminal, and an identifier of each existing network device to be activated.

The adding request response message may include a mobility configuration of a cell or cell group corresponding to the target network device.

The connection request message may include indication information and/or a UE identifier, the indication information is configured to indicate that the target network device is a network device to be activated for the UE, or to indicate that the target network device is an activated network device for the UE.

The connection establishment response message is configured to indicate that the connection establishment is successful.

In some embodiments, when a mobility operation occurs, in a case that the currently activated network device is changed, an activated network device before the change or an activated network device after the change needs to send a second change notification message to each network device to be activated. The second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In some embodiments, in response to an absence of a mobility configuration related to the terminal in the first network device, the first network device may send a connection deleting message to the currently activated network device and/or other network devices to be activated, and the connection deleting message is configured to delete a connection between the currently activated network device and the first network device and/or a connection between other network devices to be activated and the first network device.

In some embodiments, in response to an absence of a mobility configuration related to the terminal in the first network device, the currently activated network device may also send a connection cancel request message to other network devices to be activated, and the connection cancel request message is configured to instruct other network devices to be activated to delete a connection with the first network device.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

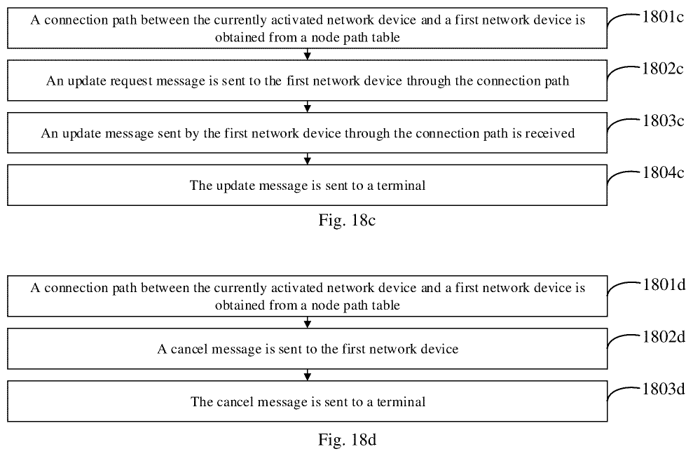

Referring to FIG. 18a, FIG. 18a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 18a, the method may include, but is not limited to, the following steps.

In step 1801a, a connection path between a currently activated network device and the first network device is obtained from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 1802a, an update request message sent by the currently activated network device is received through the connection path.

In step 1803a, an update message is sent to the currently activated network device through the connection path.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 1801a to 1803a may be realized in any manner of the embodiments of the present disclosure, which is not limited in the embodiments of the present disclosure, and will not be repeated here.

To sum up, the connection path between the currently activated network device and the first network device is obtained from the node path table, the update request message sent by the currently activated network device is received through the connection path, and the update message is sent to the currently activated network device through the connection path, so that the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 18b, FIG. 18b is a flow chart of a mobility configuration method provided by an embodiment of the present disclosure. It should be noted that the mobility configuration method of the embodiment of the present disclosure is performed by the first network device. The method may be performed independently or in combination with any other embodiment of the present disclosure. As shown in FIG. 18b, the method may include, but is not limited to, the following steps.

In step 1801b, a connection path between a currently activated network device and the first network device is obtained from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 1802b, a cancel message sent by the currently activated network device is received through the connection path.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1803b, according to the cancel message, resources reserved for a terminal are released, and/or a context of a terminal stored in the first network device is released.

In some embodiments, the reserved resources may include wireless resources, control plane resources, and the like.

In the embodiment of the present disclosure, steps 1801b to 1803b may be realized in any manner of the embodiments of the present disclosure, which is not limited in the embodiments of the present disclosure, and will not be repeated here.

To sum up, the connection path between the currently activated network device and the first network device is obtained from the node path table, the cancel message sent by the currently activated network device is received through the connection path, and the resources reserved for the terminal are released, and/or the context of the terminal stored in the first network device is released according to the cancel message, so that the network device may cancel the mobility operation of the terminal through information interaction between nodes, so as to cancel the inappropriate mobility operation in time, thus effectively improving the reliability of mobility, enhancing the communication efficiency of the system, and reducing the waste of resources.

Referring to FIG. 18c, FIG. 18c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 18c, the method may include, but is not limited to, the following steps.

In step 1801c, a connection path between the currently activated network device and a first network device is obtained from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 1802c, an update request message is sent to the first network device through the connection path.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 1803c, an update message sent by the first network device through the connection path is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 1804c, the update message is sent to a terminal.

The update message is sent to the terminal through a radio interface message to complete the update of the mobility configuration.

In the embodiment of the present disclosure, steps 1801c to 1804c may be respectively realized in any manner of the embodiments of the present disclosure, which is not limited in the embodiments of the present disclosure and will not be repeated here.

To sum up, the connection path between the currently activated network device and the first network device is obtained from the node path table, the update request message is sent to the first network device through the connection path, the update message sent by the first network device through the connection path is received, and the update message is sent to the terminal, so that the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 18d, FIG. 18d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 18d, the method may include, but is not limited to, the following steps.

In step 1801d, a connection path between the currently activated network device and a first network device is obtained from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 1802d, a cancel message is sent to the first network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 1803d, the cancel message is sent to a terminal.

The cancel message is sent to the terminal through a radio interface message to complete the cancel of the mobility operation.

In the embodiment of the present disclosure, steps 1801d to 1803d may be realized in any manner of the embodiments of the present disclosure, which is not limited in the embodiments of the present disclosure, and will not be repeated here.

To sum up, the connection path between the currently activated network device and the first network device is obtained from the node path table, the cancel message is sent to the first network device, and the cancel message is sent to the terminal, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

It may be understood that the embodiments shown in FIGS. 18a and 18c are that the currently activated network device initiates the update of the mobility configuration of the first network device, while the embodiments shown in FIGS. 18b and 18d are that the currently activated network device initiates the cancel of the mobility configuration of the first network device. That is, the embodiments shown in FIGS. 18a-18d are scenarios in which, in a case that one anchor network device is determined, the currently activated network device initiates the update or cancel of the mobility configuration of the first network device.

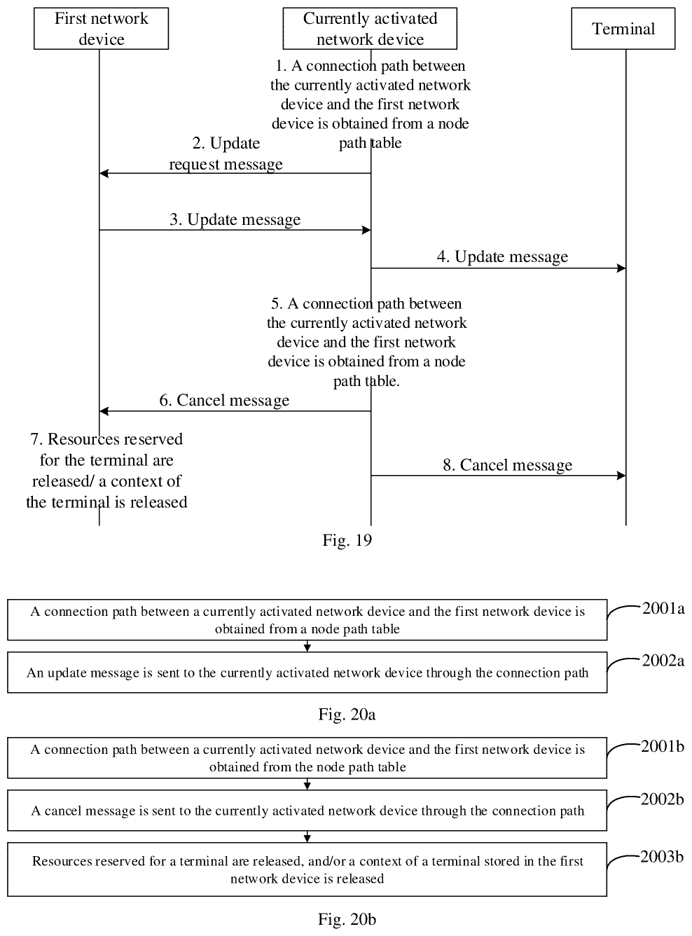

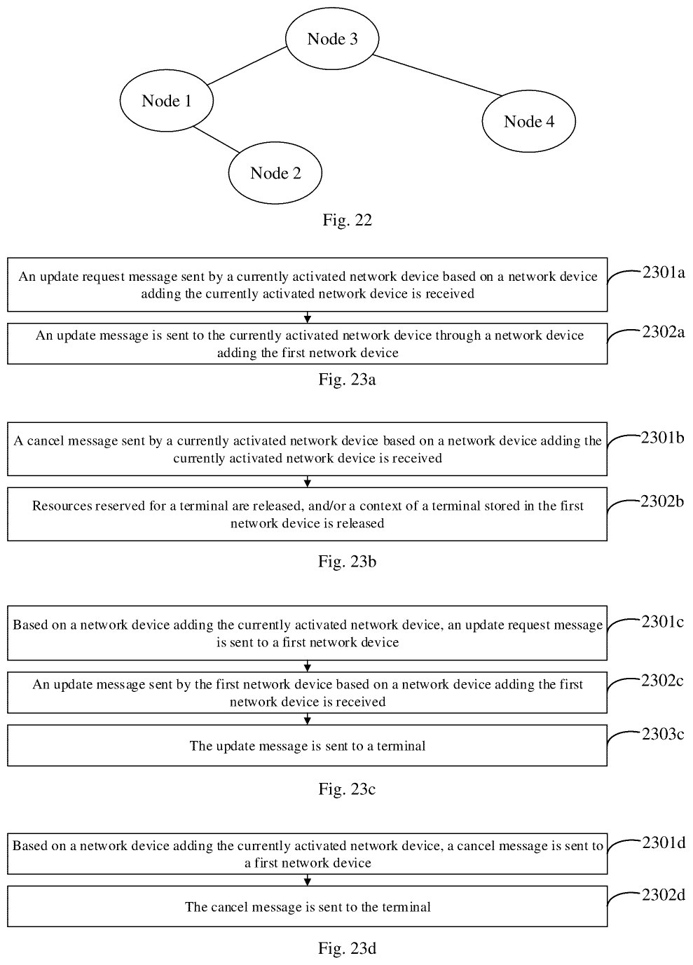

In order to better understand the mobility configuration methods in the scenarios shown in FIGS. 18a-18d, for example, reference may be made to FIG. 19, which is a flow chart of a mobility configuration method provided by an embodiment of the present disclosure. FIG. 19 shows a currently activated network device (such as node 3 in FIG. 22), a first network device (such as node 2 in FIG. 22), and a terminal.
1. The currently activated network device initiates an update of a mobility configuration on the first network device, and the currently activated network device obtains a connection path (for example, node 3-node 1-node 2 in FIG. 22) between the currently activated network device and the first network device from a node path table.
2. The currently activated network device sends an update request message to the first network device through the connection path.
3. After receiving the update request message, the first network device may also obtain the connection path between the currently activated network device and the first network device from the node path table, and send an update message to the currently activated network device.
4. After receiving the update message, the currently activated network device sends the update message to the terminal to update a corresponding mobility configuration.
5. The currently activated network device initiates a cancel of the mobility configuration on the first network device, and the currently activated network device obtains a connection path (for example, node 3-node 1-node 2 in FIG. 22) between the currently activated network device and the first network device from a node path table.
6. The currently activated network device sends a cancel message to the first network device through the connection path.
7. After receiving the cancel message, the first network device releases resources reserved for the terminal, and/or releases a context of the terminal according to the cancel message.
8. The currently activated network device sends the cancel message to the terminal to cancel a corresponding mobility operation.

It may be understood that the aforementioned steps 1-4 are to initiate the update of the mobility configuration, and steps 5-8 are to initiate the cancel of the mobility configuration. Steps 5-8 may be performed independently of steps 1-4, or part of steps 1-4 and part of steps 5-8 may be performed. Performing some or all of steps of 1-4 and 5-8 are within the protection scope of the present disclosure. An execution sequence of steps 1-4 and 5-8 is not limited in this embodiment, for example, steps 5 and 8 may be executed at the same time, or step 5 is executed before step 8, or step 8 is executed before step 5, which is not limited in this embodiment. Any execution sequence and combination of any one or more of the above steps are within the protection scope of the present disclosure.

In the embodiment of the present disclosure, the currently activated network device and the first network device may obtain the connection path between the currently activated network device and the first network device from the node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in a network device, either in a core network device or in an access network device.

The node path table is shown in FIG. 22. During initial configuration, in a case that the network needs to configure a specific mobility operation (for example, a selective activation of cell groups) for the UE, one node path table is set for the UE on one network device, a serving node (that is, an initially activated network device, node 1 in the figure) during the initial configuration is stored as an initial node, candidate nodes (node 2 and node 3) configured by node 1 are stored, and paths between a current node and the candidate nodes are stored. The candidate node is the network device to be activated.

In some embodiments, when the currently activated network device (node 3) newly adds a mobility configuration to the UE, in a case that a target network device (node 4) corresponding to this mobility configuration is not a currently existing network device to be activated, the node path table is updated, the target network device is added as a new node, and a connection path between the target network device and the currently activated network device (node 3) is stored.

In some embodiments, in response to a presence of an independent node that is not connected with other nodes in the node path table, this node in the table is deleted, and a currently activated node establishes a connection with it, or this node is removed from the node path table and a mobility configuration corresponding to the node on the UE side is deleted.

In some embodiments, when a mobility operation occurs, in a case that the currently activated network device is changed, an activated network device before the change or an activated network device after the change needs to send a second change notification message to each network device to be activated. The second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In the embodiment of the present disclosure, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In some embodiments, in response to an absence of a mobility configuration related to the terminal in the first network device, first indication information is sent to a network device storing the node path table, and the first indication information is configured for the network device storing the node path table to delete the first network device and a path connected to the first network device in the node path table.

In some embodiments, in response to an absence of a mobility configuration related to the terminal in the first network device, the currently activated network device may also send first indication information to a network device storing the node path table, and the first indication information is configured for the network device storing the node path table to delete the first network device and a path connected to the first network device in the node path table.

In the embodiment of the present disclosure, in a case that there are a plurality of paths between two nodes, the shortest path is selected as a transmission path of messages between the nodes, that is, the shortest path is selected as the obtained connection path.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

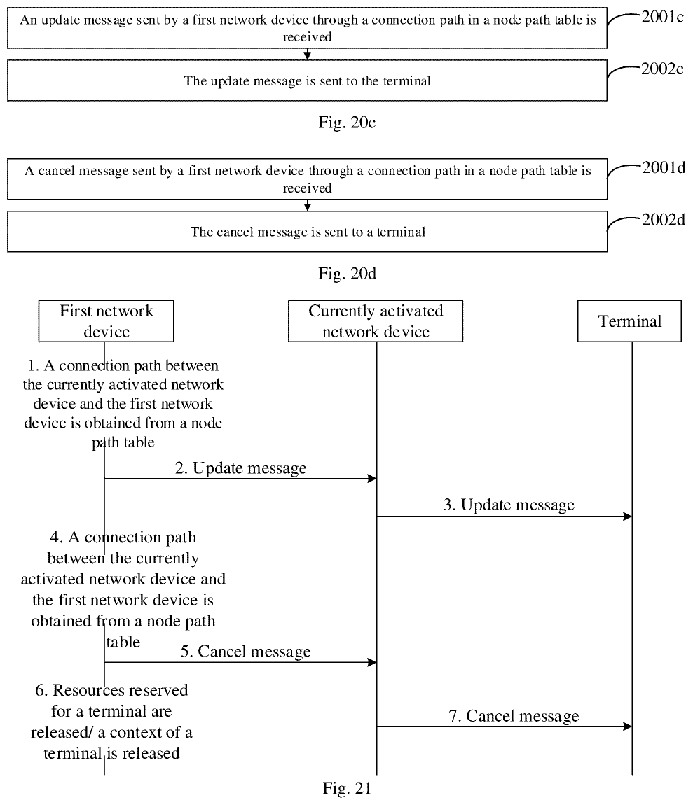

Referring to FIG. 20a, FIG. 20a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 20a, the method may include, but is not limited to, the following steps.

In step 2001a, a connection path between a currently activated network device and the first network device is obtained from a node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 2002a, an update message is sent to the currently activated network device through the connection path.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 2001a to 2002a may be realized in any manner of the embodiments of the present disclosure, which is not limited in the embodiments of the present disclosure, and will not be repeated here.

To sum up, the connection path between the currently activated network device and the first network device is obtained from the node path table, and the update message is sent to the currently activated network device through the connection path, so that the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 20b, FIG. 20b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 20b, the method may include, but is not limited to, the following steps.

In step 2001b, a connection path between a currently activated network device and the first network device is obtained from the node path table.

The node path table includes one or more of: an initially activated network device, each network device to be activated added by the initially activated network device, and each network device to be activated added by a subsequently activated network device. Two network devices in the node path table have a direct or indirect connection path therebetween.

In step 2002b, a cancel message is sent to the currently activated network device through the connection path.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2003b, resources reserved for a terminal are released, and/or a context of a terminal stored in the first network device is released.

In some embodiments, the reserved resources may include wireless resources, control plane resources, and the like.

In the embodiment of the present disclosure, steps 2001b to 2003b may be realized in any manner of the embodiments of the present disclosure, which is not limited in the embodiments of the present disclosure, and will not be repeated here.

To sum up, the connection path between the currently activated network device and the first network device is obtained from the node path table, the cancel message sent by the currently activated network device is received through the connection path, and the resources reserved for the terminal are released, and/or the context of the terminal stored in the first network device is released according to the cancel message, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 20c, FIG. 20c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 20c, the method may include, but is not limited to, the following steps.

In step 2001c, an update message sent by a first network device through a connection path in a node path table is received.

The node path table includes one or more of: an initially activated network device, each network device to be activated added by the initially activated network device, and each network device to be activated added by a subsequently activated network device. Two network devices in the node path table have a direct or indirect connection path therebetween.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 2002c, the update message is sent to the terminal.

The update message is sent to the terminal through a radio interface message to complete the update of the mobility configuration.

In the embodiment of the present disclosure, steps 2001c to 2002c may be realized in any manner of the embodiments of the present disclosure, which is not limited in the embodiments of the present disclosure, and will not be repeated here.

To sum up, by receiving the update message sent by the first network device through the connection path in the node path table and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 20d, FIG. 20d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 20d, the method may include, but is not limited to, the following steps.

In step 2001d, a cancel message sent by a first network device through a connection path in a node path table is received.

The node path table includes one or more of: an initially activated network devices, each network device to be activated added by the initially activated network device, and each network device to be activated added by a subsequently activated network device. Two network devices in the node path table have a direct or indirect connection path therebetween.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2002d, the cancel message is sent to a terminal.

The cancel message is sent to the terminal through a radio interface message to complete the cancel of the mobility operation.

In the embodiment of the present disclosure, steps 2001d to 2002d may be realized in any manner of the embodiments of the present disclosure, which is not limited in the embodiment of the present disclosure, and will not be repeated here.

To sum up, by receiving the cancel message sent by the first network device through the connection path in the node path table and sending the cancel message to the terminal, the network device may cancel the mobility operation of the terminal through information interaction between nodes, so as to cancel the inappropriate mobility operation in time, effectively improving the reliability of mobility, enhancing the communication efficiency of the system and reducing the waste of resources.

It may be understood that the embodiments shown in FIGS. 20a and 20c are that the currently activated network device initiates the update of the mobility configuration of the first network device, while the embodiments shown in FIGS. 20b and 20d are that the currently activated network device initiates the cancel of the mobility configuration of the first network device. That is, the embodiments shown in FIGS. 20a-20d are scenarios in which, in a case that one anchor network device is determined, the currently activated network device initiates the update or cancel of the mobility configuration of the first network device.

In order to better understand the mobility configuration methods in the scenarios shown in FIGS. 20a-20d, for example, reference may be made to FIG. 21, which is a flow chart of a mobility configuration method provided by an embodiment of the present disclosure. FIG. 21 shows a currently activated network device (such as node 3 in FIG. 22), a first network device (such as node 2 in FIG. 22), and a terminal.
1. The first network device initiates an update of a mobility configuration on the first network device, and the first network device obtains a connection path between the currently activated network device and the first network device from a node path table.
2. The first network device sends an update message to the currently activated network device through the connection path.
3. After receiving the update message, the currently activated network device sends the update message to the terminal to update a corresponding mobility configuration.
4. The first network device initiates a cancel of the mobility configuration on the first network device, and the first network device obtains a connection path between the currently activated network device and the first network device from a node path table.
5. The first network device sends a cancel message to the currently activated network device through the connection path.
6. The first network device releases resources reserved for the terminal, and/or releases a context of the terminal.
7. The currently activated network device sends the cancel message to the terminal to cancel a corresponding mobility operation.

It may be understood that the aforementioned steps 1-3 are to initiate the update of the mobility configuration, and steps 4-7 are to initiate the cancel of the mobility configuration. Steps 4-7 may be performed independently of steps 1-3, or part of steps 1-3 and part of steps 4-7 may be performed. Performing some or all of steps of 1-3 and 4-7 are within the protection scope of the present disclosure. An execution sequence of steps 1-3 and 4-7 is not limited in this embodiment. Any execution sequence and combination of any one or more of the above steps are within the protection scope of the present disclosure.

In the embodiment of the present disclosure, the currently activated network device and the first network device may obtain the connection path between the currently activated network device and the first network device from the node path table.

The node path table includes one or more of: an initially activated network device, each network device to be activated added by the initially activated network device, and each network device to be activated added by a subsequently activated network device. Two network devices in the node path table have a direct or indirect connection path therebetween.

It should be noted that the node path table is stored in the network device, either in a core network device or in an access network device.

The node path table is shown in FIG. 22. During initial configuration, in a case that the network needs to configure a specific mobility operation (for example, a selective activation of cell groups) for the UE, one node path table is set for the UE on one network device, a serving node (that is, an initially activated network device, node 1 in the figure) during the initial configuration is stored as an initial node, candidate nodes (node 2 and node 3) configured by node 1 are stored, and paths between a current node and the candidate nodes are stored. The candidate node is the network device to be activated.

In some embodiments, when the currently activated network device (node 3) newly adds a mobility configuration to the UE, in a case that a target network device (node 4) corresponding to this mobility configuration is not a currently existing network device to be activated, the node path table is updated, the target network device is added as a new node, and a connection path between the target network device and the currently activated network device (node 3) is stored.

In some embodiments, in response to a presence of an independent node that is not connected with other nodes in the node path table, this standard node is deleted, and a currently activated node establishes a connection with this node, or this node is removed from the node path table and a mobility configuration corresponding to the node on the UE side is deleted.

In some embodiments, when a mobility operation occurs, in a case that the currently activated network device is changed, an activated network device before the change or an activated network device after the change needs to send a second change notification message to each network device to be activated. The second change notification message is configured to notify that the currently activated network device is changed.

In some embodiments, the second change notification message may include an identifier of the activated network device after the change.

In the embodiment of the present disclosure, the update message includes at least one of: a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, the cancel message includes at least one of: a cell identifier corresponding to a cancelled mobility operation; a cell group identifier corresponding to the cancelled mobility operation; and a network device identifier corresponding to the cancelled mobility operation.

In the embodiment of the present disclosure, the cancel message may be configured to cancel all mobility operations on a network device that receives the cancel message.

In some embodiments, the cancel message may cancel all mobility configurations configured on the first network device (the cancel message may not carry the cell identifier, the cell group identifier and the network device identifier).

In some embodiments, in response to an absence of a mobility configuration related to the terminal in the first network device, first indication information is sent to a network device storing the node path table, and the first indication information is configured for the network device storing the node path table to delete the first network device and a path connected to the first network device in the node path table.

In some embodiments, in response to an absence of a mobility configuration related to the terminal in the first network device, the currently activated network device may also send first indication information to a network device storing the node path table, and the first indication information is configured for the network device storing the node path table to delete the first network device and a path connected to the first network device in the node path table.

In the embodiment of the present disclosure, in a case that there are a plurality of paths between two nodes, the shortest path is selected as a transmission path of messages between the nodes, that is, the shortest path is selected as the obtained connection path.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

Referring to FIG. 23a, FIG. 23a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 23a, the method may include, but is not limited to, the following steps.

In step 2301a, an update request message sent by a currently activated network device based on a network device adding the currently activated network device is received.

In step 2302a, an update message is sent to the currently activated network device through a network device adding the first network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, steps 2301a to 2302a may be realized in any manner of the embodiments of the present disclosure, which is not limited in the embodiments of the present disclosure, and will not be repeated here.

To sum up, by receiving the update request message sent by the currently activated network device based on the network device adding the currently activated network device, and sending the update message to the currently activated network device through the network device adding the first network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 23b, FIG. 23b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 23b, the method may include, but is not limited to, the following steps.

In step 2301b, a cancel message sent by a currently activated network device based on a network device adding the currently activated network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2302b, according to the cancel message, resources reserved for a terminal are released, and/or a context of a terminal stored in the first network device is released.

In some embodiments, the reserved resources may include wireless resources, control plane resources, and the like.

In the embodiment of the present disclosure, steps 2301b to 2302b may be respectively realized in any manner of the embodiments of the present disclosure, which is not limited in the embodiments of the present disclosure, and will not be repeated here.

To sum up, by receiving the cancel message sent by the currently activated network device based on the network device adding the currently activated network device, and releasing the resources reserved for the terminal, and/or releasing the context of the terminal stored in the first network device according to the cancel message, the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 23c, FIG. 23c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 23c, the method may include, but is not limited to, the following steps.

In step 2301c, based on a network device adding the currently activated network device, an update request message is sent to a first network device.

In some embodiments, the update request message may include at least one of: a cell identifier corresponding to a mobility configuration requested to be updated; a cell group identifier corresponding to the mobility configuration requested to be updated; and a network device identifier corresponding to the mobility configuration requested to be updated.

In step 2302c, an update message sent by the first network device based on a network device adding the first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 2303c, the update message is sent to a terminal.

The update message is sent to the terminal through a radio interface message to complete the update of the mobility configuration.

In the embodiment of the present disclosure, steps 2301c to 2303c may be respectively realized in any manner of the embodiments of the present disclosure, which is not limited in the embodiments of the present disclosure, and will not be repeated here.

To sum up, by sending the update request message to the first network device based on the network device adding the currently activated network device, receiving the update message sent by the first network device based on the network device adding the first network device, and sending the update message to the terminal, the network device may update the mobility configuration of the terminal through information interaction between nodes, so as to update the mobility configuration in time, thus effectively improving the reliability of mobility, enhancing the communication efficiency of the system, and reducing the waste of resources.

Referring to FIG. 23d, FIG. 23d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 23d, the method may include, but is not limited to, the following steps.

In step 2301d, based on a network device adding the currently activated network device, a cancel message is sent to a first network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2302d, the cancel message is sent to the terminal.

The cancel message is sent to the terminal through a radio interface message to complete the cancel of the mobility operation.

In the embodiment of the present disclosure, steps 2301d to 2302d may be respectively realized in any manner of the embodiments of the present disclosure, which is not limited in the embodiments of the present disclosure, and will not be repeated here.

To sum up, by sending the cancel message to the first network device based on the network device adding the currently activated network device, and sending the cancel message to the terminal, the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

It may be understood that the embodiments shown in FIGS. 23a and 23c are that the currently activated network device initiates the update of the mobility configuration of the first network device, while the embodiments shown in FIGS. 23b and 23d are that the currently activated network device initiates the cancel of the mobility configuration of the first network device. That is, the embodiments shown in FIGS. 23a-23d are scenarios in which, in a case that one anchor network device is determined, the currently activated network device initiates the update or cancel of the mobility configuration of the first network device.

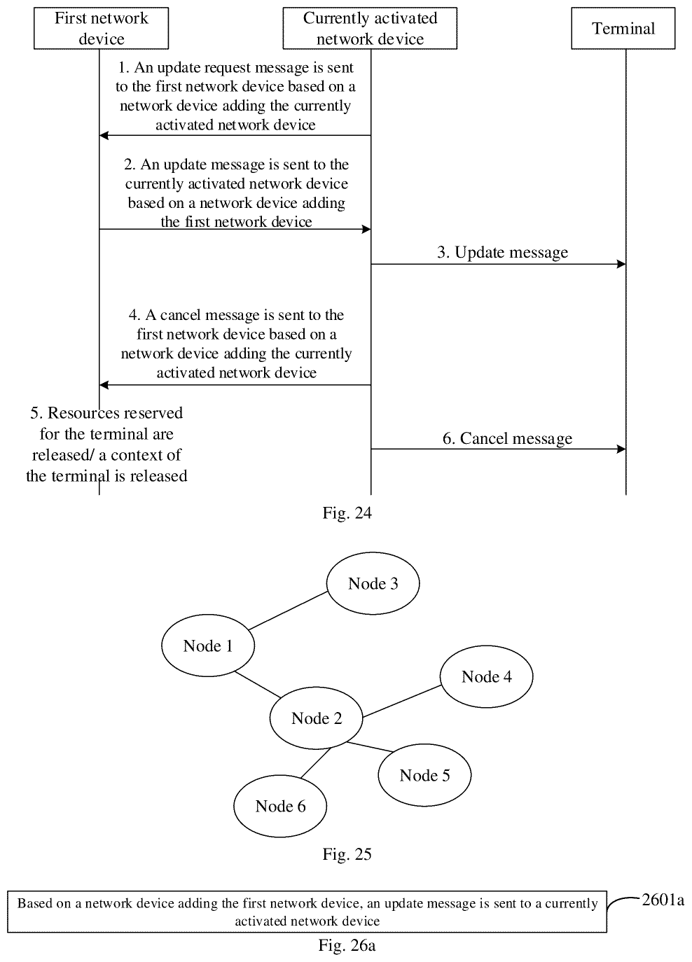

In order to better understand the mobility configuration methods in the scenarios shown in FIGS. 23a-23d, for example, reference may be made to FIG. 24, which is a flow chart of a mobility configuration method provided by an embodiment of the present disclosure. FIG. 24 shows a currently activated network device, a first network device, and a terminal.
1. The currently activated network device initiates an update of a mobility configuration on the first network device, and the currently activated network device sends an update request message to the first network device based on a network device adding the currently activated network device.

It may be understood that in a case that there is a direct connection between the currently activated network device and the first network device, the currently activated network device may directly send the update request message to the first network device.
2. After receiving the update request message, the first network device may send an update message to the currently activated network device based on a network device adding the first network device.

It may be understood that in a case that there is a direct connection between the currently activated network device and the first network device, the first network device may directly send the update message to the currently activated network device.
3. After receiving the update message, the currently activated network device sends the update message to the terminal to update a corresponding mobility configuration.
4. The currently activated network device initiates a cancel of the mobility configuration on the first network device, and the currently activated network device sends a cancel message to the first network device based on the network device adding the currently activated network device.

It may be understood that the path and mode of message transmission in step 4 are the same as those in step 1.
5. After receiving the cancel message, the first network device releases resources reserved for the terminal, and/or releases a context of the terminal according to the cancel message.
6. The currently activated network device sends the cancel message to the terminal to cancel a corresponding mobility operation.

It may be understood that the aforementioned steps 1-3 are to initiate the update of the mobility configuration, and steps 4-6 are to initiate the cancel of the mobility configuration. Steps 4-6 may be performed independently of steps 1-3, or part of steps 1-3 and part of steps 4-6 may be performed. Performing some or all of steps 1-3 and 4-6 is within the protection scope of the present disclosure. An execution sequence of steps 1-3 and 4-6 is not limited in this embodiment, for example, steps 4 and 6 may be executed at the same time, or step 4 is executed before step 6, or step 6 is executed before step 4, which is not limited in this embodiment. Any execution sequence and combination of any one or more of the above steps are within the protection scope of the present disclosure.

In order to better understand the above step 1, referring to FIG. 25, FIG. 25 is a node connection relationship diagram. In FIG. 25, node 1 serves as an initial serving node, and nodes 2 and 3 are added. When node 2 serves as the serving node subsequently, nodes 4, 5 and 6 are further added. At present, the currently activated network device is node 3, and the first network device is node 6. There is no direct connection between node 3 and node 6, so node 3 needs to send the update request message to node 6 based on the node adding node 3, i.e., node 1. That is, node 3 sends the update request message to node 1. Moreover, there is no direct connection between node 1 and node 6. As the initial serving node (the initially activated network device), node 1 sends the update request message to node 2 added by itself, and node 2 sends the update request message to node 6 added by itself.

It should be noted that, in a case that node 1 is not the initial serving node, node 1 continues to send the message to the node adding node 1 until the initial serving node receives the message and sends the message to other nodes added by the initial serving node, and finally to node 6.

Step 2 is similar to Step 1. As shown in FIG. 25, the first network device is node 6, and the currently activated network device is node 3. There is no direct connection between node 3 and node 6. Therefore, node 6 needs to send the update message to node 3 based on the node adding node 6, i.e., node 2. That is, node 6 sends the update message to node 2. Moreover, there is no direct connection between node 2 and node 3, and node 2 continues to send the update message to node 3 based on the node adding node 2, i.e., node 1. That is, node 2 sends the update message to node 1. Node 1 then sends the update message to node 3.

As an example, the currently activated network device initiates the update of the mobility configuration of the first network device, which may further include, but is not limited to, one or more of the following steps.

The first network device is a network device to be activated. The currently activated network device may initiate the update of the mobility configuration of at least one network device to be activated.
(1-1) The currently activated network device sends an update request message to the first network device.

As a possibility, there is a connection between the currently activated network device and the first network device, the currently activated network device sends the update request message to the first network device.

As another possibility, there is no connection between the currently activated network device and the first network device, the currently activated network device sends the update request message to the network device adding the activated network device, and the update request message is forwarded to the first network device by the network device adding the activated the network device.
(1-2) After receiving the update request message, the first network device sends an update message to the currently activated network device through the path in step (1-1).
(1-3) The currently activated network device sends the update message to the terminal through a radio interface message to complete the update of the mobility configuration of the terminal.

As an example, the currently activated network device initiates the cancel of the mobility configuration of the first network device, which may also include, but is not limited to, one or more of the following steps.

The first network device is a network device to be activated. The currently activated network device may initiate the cancel of the mobility configuration of at least one network device to be activated.
(2-1) The currently activated network device sends a cancel message to the first network device.

It may be understood that the path for sending the cancel message may be the same as the path in step (1-1) in the aforementioned example of the update of the mobility configuration.
(2-2) After receiving the cancel message, the first network device may release corresponding resources reserved for the terminal, including wireless resources and control plane resources, and/or release a context of the terminal.
(2-3) The currently activated network device sends the cancel message to the terminal through a radio interface message to cancel a corresponding mobility operation of the terminal.

In the embodiment of the present disclosure, there is a direct or indirect connection path between the currently activated network device and the first network device, and the connection path may be found based on nodes adding themselves.

In some embodiments, when a mobility operation occurs, in a case that the currently activated network device is changed, the originally activated network device needs to send a second change notification message to each network device to be activated connected with it, and each network device to be activated connected with the originally activated network device may send the second change notification message to each network device to be activated connected with itself . . . . The second change notification message is configured to notify that the currently activated network device is changed.

In some embodiments, the second change notification message may include an identifier of the activated network device after the change.

For example, when the mobility operation occurs, in a case that the activated node is changed, the originally activated node needs to send the second change notification message to the node to be activated which has a connection with it, so as to notify that the activated node is changed to be the currently activated node.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

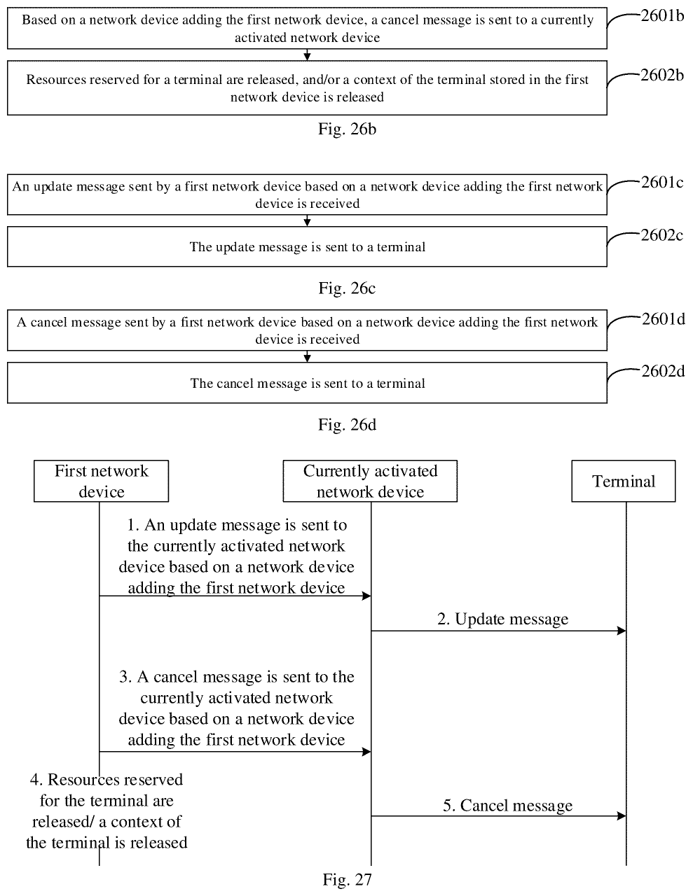

Referring to FIG. 26a, FIG. 26a is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 26a, the method may include, but is not limited to, the following steps.

In step 2601a, based on a network device adding the first network device, an update message is sent to a currently activated network device.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In the embodiment of the present disclosure, step 2601a may be realized in any manner of the embodiments of the present disclosure, which is not limited in the embodiments of the present disclosure, and will not be repeated here.

To sum up, by sending the update message to the currently activated network device based on the network device adding the first network device, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 26b, FIG. 26b is a flow chart of a mobility configuration method provided by an embodiment of the present disclosure. It should be noted that the mobility configuration method of the embodiment of the present disclosure is performed by a first network device. The method may be performed independently or in combination with any other embodiment of the present disclosure. As shown in FIG. 26b, the method may include, but is not limited to, the following steps.

In step 2601b, based on a network device adding the first network device, a cancel message is sent to a currently activated network device.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2602b, resources reserved for a terminal are released, and/or a context of the terminal stored in the first network device is released.

In some embodiments, the reserved resources may include wireless resources, control plane resources, and the like.

In the embodiment of the present disclosure, steps 2601b to 2602b may be respectively realized in any manner of the embodiments of the present disclosure, which is not limited in the embodiments of the present disclosure, and will not be repeated here.

To sum up, by sending the cancel message to the currently activated network device based on the network device adding the first network device, the resources reserved for the terminal are released, and/or the context of the terminal stored in the first network device is released, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 26c, FIG. 26c is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 26c, the method may include, but is not limited to, the following steps.

In step 2601c, an update message sent by a first network device based on a network device adding the first network device is received.

In some embodiments, the update message includes at least one of:
a mobility configuration updated by the first network device; a cell identifier corresponding to the updated mobility configuration; a cell group identifier corresponding to the updated mobility configuration; and a network device identifier corresponding to the updated mobility configuration.

In step 2602c, the update message is sent to a terminal.

The update message is sent to the terminal through a radio interface message to complete the update of the mobility configuration.

In the embodiment of the present disclosure, steps 2601c to 2602c may be respectively realized in any manner of the embodiments of the present disclosure, which is not limited in the embodiments of the present disclosure, and will not be repeated here.

To sum up, by receiving the update message sent by the first network device based on the network device adding the first network device and sending the update message to the terminal, the network device may update the mobility configuration of the terminal through information interaction between nodes, so as to update the mobility configuration in time, thus effectively improving the reliability of mobility, enhancing the communication efficiency of the system and reducing the waste of resources.

Referring to FIG. 26d, FIG. 26d is a flow chart of a mobility configuration method provided by an embodiment of the present disclosure. It should be noted that the mobility configuration method of the embodiment of the present disclosure is performed by a currently activated network device. The method may be performed independently or in combination with any other embodiment of the present disclosure. As shown in FIG. 26d, the method may include, but is not limited to, the following steps.

In step 2601d, a cancel message sent by a first network device based on a network device adding the first network device is received.

In some embodiments, the cancel message includes at least one of:
a cell identifier corresponding to a cancelled mobility operation; a cell group identifier corresponding to the cancelled mobility operation; and a network device identifier corresponding to the cancelled mobility operation.

In step 2602d, the cancel message is sent to a terminal.

The cancel message is sent to the terminal through a radio interface message to complete the cancel of the mobility operation.

In the embodiment of the present disclosure, steps 2601d to 2602d may be respectively realized in any manner of the embodiments of the present disclosure, which is not limited in the embodiments of the present disclosure, and will not be repeated here.

To sum up, by receiving the cancel message sent by the first network device based on the network device adding the first network device and sending the cancel message to the terminal, the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

It may be understood that the embodiments shown in FIGS. 26a and 26c are that the currently activated network device initiates the update of the mobility configuration of the first network device, while the embodiments shown in FIGS. 26b and 26d are that the currently activated network device initiates the cancel of the mobility configuration of the first network device. That is, the embodiments shown in FIGS. 26a-26d are scenarios in which, in a case that one anchor network device is determined, the currently activated network device initiates the update or cancel of the mobility configuration of the first network device.

In order to better understand the mobility configuration methods in the scenarios shown in FIGS. 26a-26d, for example, reference may be made to FIG. 27, which is a flow chart of a mobility configuration method provided by an embodiment of the present disclosure. FIG. 27 shows a currently activated network device, a first network device, and a terminal.
1. The first network device initiates an update of a mobility configuration on the first network device, and the first network device sends an update message to the currently activated network device based on a network device adding the first network device.

It may be understood that, in a case that there is a direct connection between the currently activated network device and the first network device, the currently activated network device may directly send the update request message to the first network device.

In order to better understand step 1, reference may be made to FIG. 25, which is a node connection relationship diagram. In FIG. 25, node 1 serves as an initial serving node, and nodes 2 and 3 are added. When node 2 serves as a serving node subsequently, nodes 4, 5 and 6 are further added. At present, the currently activated network device is node 3, and the first network device is node 6. There is no direct connection between node 3 and node 6, so node 6 needs to send the update message to node 3 based on the node adding node 6, i.e., node 2. That is, node 6 sends the update message to node 2. Moreover, there is no direct connection between node 2 and node 3, and node 2 continues to send the update message to node 3 based on the node adding node 2, i.e., node 1. That is, node 2 sends the update message to node 1. Node 1 then sends the update message to node 3.

It should be noted that, in a case that node 1 is not the initial serving node, node 1 continues to send the message to the node adding node 1 until the initial serving node receives the message and sends the message to other nodes added by the initial serving node, and finally to node 3.
2. After receiving the update message, the currently activated network device sends the update message to the terminal to update a corresponding mobility configuration.
3. The first network device initiates a cancel of the mobility configuration on the first network device, and the first network device sends a cancel message to the currently activated network device based on a network device adding the first network device.

It may be understood that the path and mode of message transmission in step 3 are the same as those in step 1.
4. The first network device releases resources reserved for the terminal, and/or releases a context of the terminal.
5. The currently activated network device sends the cancel message to the terminal to cancel a corresponding mobility operation.

It may be understood that the aforementioned steps 1-2 are to initiate the update of the mobility configuration, and steps 3-5 are to initiate the cancel of the mobility configuration. Steps 3-5 may be performed independently of steps 1-2, and part of steps 1-2 and part of steps 3-5 may also be performed. Performing some or all of steps of 1-2 and 3-5 is within the protection scope of the present disclosure. An execution sequence of steps 1-2 and 3-5 is not limited in this embodiment. Any execution sequence and combination of any one or more of the above steps are within the protection scope of the present disclosure.

As an example, the currently activated network device initiates the update of the mobility configuration of the first network device, which may also include, but is not limited to, one or more of the following steps.

The first network device is a network device to be activated. The currently activated network device may initiate the update of the mobility configuration of at least one network device to be activated.
(1-1) The first network device sends an update message to the currently activated network device.

As a possibility, there is a connection between the currently activated network device and the first network device, and the first network device sends the update message to the currently activated network device.

As another possibility, there is no connection between the currently activated network device and the first network device, the first network device sends the update message to the network device adding the first network device and the update message is forwarded to the currently activated network device through the network device adding the first network device.
(1-2) The currently activated network device sends the update message to the terminal through a radio interface message to complete the update of the mobility configuration of the terminal.

As an example, the currently activated network device initiates the cancel of the mobility configuration of the first network device, which may also include, but is not limited to, one or more of the following steps.

The first network device is a network device to be activated. The currently activated network device may initiate the cancel of the mobility configuration of at least one network device to be activated.
(2-1) The first network device sends a cancel message to the currently activated network device, and may release corresponding resources reserved for the terminal, including wireless resources and control plane resources, and/or release a context of the terminal.

It may be understood that the path for sending the cancel message may be the same as the path in step (1-1) in the aforementioned example of the update of the mobility configuration.
(2-2) The currently activated network device sends the cancel message to the terminal through a radio interface message to cancel a corresponding mobility operation of the terminal.

In the embodiment of the present disclosure, there is a direct or indirect connection path between the currently activated network device and the first network device, and the connection path may be found based on nodes adding themselves.

In some embodiments, when a mobility operation occurs, in a case that the currently activated network device is changed, the originally activated network device needs to send a second change notification message to each network device to be activated that is connected with it, and each network device to be activated that is connected with the originally activated network device may send the second change notification message to each network device to be activated connected with itself . . . . The second change notification message is configured to notify that the currently activated network device is changed.

In some embodiments, the second change notification message may include an identifier of the activated network device after the change.

For example, when the mobility operation occurs, in a case that the activated node is changed, the originally activated node needs to send the second change notification message to the node to be activated that has a connection with it to notify that the activated node is changed to be the currently activated node.

It should be noted that in various embodiments of the present disclosure, two network devices may be connected through an Xn interface.

To sum up, the mobility configuration method provided by the embodiment of the present disclosure enables the network device to cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

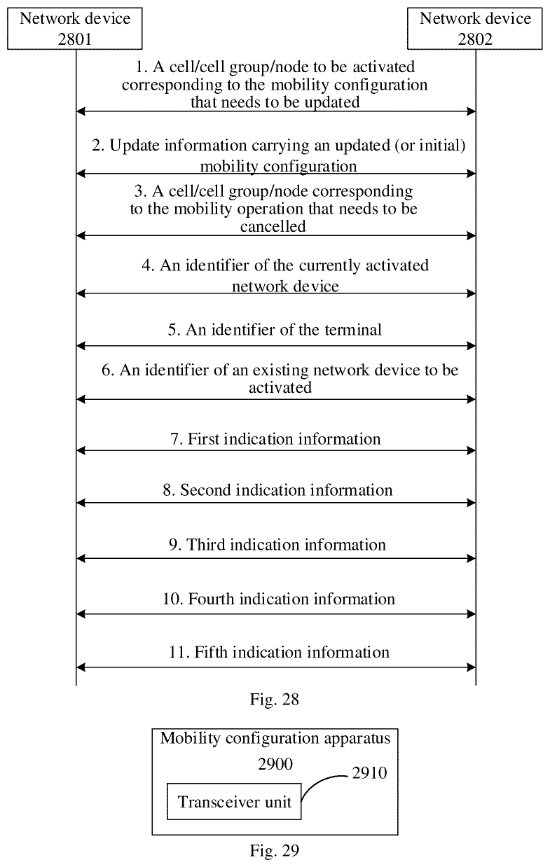

In the above embodiments of the present disclosure, information may be exchanged and forwarded between any two of the network device to be activated, the currently activated network device, the anchor network device and the target network device through messages between nodes. The update of the mobility configuration is realized, or the mobility operation on a certain cell/cell group/node or the UE context on a certain node is released. As shown in FIG. 28, a network device 2801 in FIG. 28 may be any one of the network device to be activated, the currently activated network device, the anchor network device and the target network device, and a network device 2802 may be any one of the network device to be activated, the currently activated network device, the anchor network device and the target network device.

The above messages between nodes may include, but are not limited to, at least one of the following information:
1. a cell to be activated corresponding to a mobility configuration that needs to be updated; and/or a cell group to be activated corresponding to the mobility configuration that needs to be updated; and/or a network device to be activated corresponding to the mobility configuration that needs to be updated;
2. mobility configuration information carrying an updated (or initial) mobility configuration, and/or a cell corresponding to the mobility configuration; and/or a cell group corresponding to the mobility configuration; and/or a node corresponding to the mobility configuration;
3. a cell to be activated corresponding to a mobility operation that needs to be cancelled; and/or a cell group corresponding to the mobility operation that needs to be cancelled; and/or a node corresponding to the mobility operation that needs to be cancelled, in which the mobility operation includes, but is not limited to, any one or more of a cell group selective activation and a cell group activation;
4. an identifier of the currently activated network device;
5. an identifier of the terminal;
6. an identifier of at least one existing network device to be activated;
7. first indication information, the first indication information being configured to indicate that a node sending the first indication information becomes a node to be activated or an activated node of the terminal;
8. second indication information, the second indication information being configured to indicate that a connection between network devices is established successfully;
9. third indication information, the third indication information being configured to indicate to cancel a specific mobility operation (such as a cell group selective activation) on a corresponding node;
10. fourth indication information, the fourth indication information being configured to indicate to update a specific mobility configuration (such as a configuration of a cell group selective activation) on a corresponding node.
11. fifth indication information, the fifth indication information indicating that this inter-node message is used for a specific mobility operation (such as a cell group selective activation).

In the above-mentioned embodiments of the present disclosure, the messages exchanged between the network devices may be existing inter-node messages or newly defined inter-node messages. In some embodiments, the inter-node messages include, but are not limited to, any one or more of a mobility configuration update related message, a mobility configuration cancel related inter-node message, a connection establishment/cancel related message, and a change notification message.

For example, the mobility configuration update related message includes one or more of an update message and an update request message.

For example, the mobility configuration cancel related message includes: a cancel message.

For example, the change notification message includes one or more of a first change notification message and a second change notification message.

In some embodiments, the mobility configuration update related message may be one or more of:
Handover Request: Handover Request Acknowledge; S-Node Addition Request; S-Node Addition Request Acknowledge; S-Node Modification Request; S-Node Modification Request Acknowledge; S-Node Modification Required; S-Node Modification Confirm; S-Node Change Required; S-Node Change Confirm.

In some embodiments, the mobility configuration cancel related message may be one or more of:
Conditional Handover Cancel; Handover Cancel; Conditional Pscell Change Cancel; S-Node Change Required; Ue Context Release; S-Node Release Request; S-Node Release Request Acknowledge; S-Node Release Reject; S-Node Release Required; S-Node Release Confirm.
   In some embodiments, the connection establishment/cancel related message may be one or more of:
Xn Setup Request; Xn Removal Request.

Corresponding to the mobility configuration methods provided in the above embodiments, the present disclosure also provides a mobility configuration apparatus. Since the mobility configuration apparatus provided in the embodiment of the present disclosure corresponds to the methods provided in the above embodiments, the implementations of the mobility configuration method are also applicable to the mobility configuration apparatus provided in the following embodiments, which will not be repeated here.

Referring to FIG. 29, FIG. 29 is a schematic diagram of a mobility configuration apparatus provided by an embodiment of the present disclosure.

As shown in FIG. 29, the mobility configuration apparatus 2900 includes a transceiver unit 2910.

The transceiver unit 2910 is configured to send an update message or a cancel message to a second network device.

The update message is configured to update a mobility configuration of a terminal, and the cancel message is configured to cancel a mobility operation corresponding to a first network device in a terminal.

In some embodiments, the first network device is a network device to be activated, and the second network device is any one of: an anchor network device; and a currently activated network device. The network device to be activated is a network device corresponding to a cell or cell group to be activated; and the currently activated network device is a network device corresponding to a currently activated cell or cell group.

In some embodiments, the anchor network device has a connection with the first network device, and the anchor network device has a connection with the currently activated network device.

In some embodiments, the transceiver unit 2910 is further configured to receive an update request message sent by the anchor network device. The update request message is configured to request the first network device to update the mobility configuration.

In some embodiments, the transceiver unit 2910 is further configured to receive an update request message sent by the currently activated network device through the anchor network device. The update request message is configured to request the first network device to update the mobility configuration.

In some embodiments, the transceiver unit 2910 is further configured to: in response to a change of the anchor network device, receive a first change notification message sent by an anchor network device before the change or an anchor network device after the change. The first change notification message is configured to notify that the anchor network device is changed.

In some embodiments, the currently activated network device has a connection with each network device to be activated.

In some embodiments, the transceiver unit 2910 is further configured to receive an update request message sent by the currently activated network device. The update request message is configured to request the first network device to update the mobility configuration.

In some embodiments, the transceiver unit 2910 is further configured to: in response to a change of the currently activated network device, receive a second change notification message sent by an activated network device before the change or an activated network device after the change. The second change notification message is configured to notify that the currently activated network device is changed.

In some embodiments, the transceiver unit 2910 is further configured to obtain a connection path between the currently activated network device and the first network device from a node path table. The node path table includes one or more of: an initially activated network device, each network device to be activated added by the initially activated network device, and each network device to be activated added by a subsequently activated network device. Two network devices in the node path table have a direct or indirect connection path therebetween.

In some embodiments, the transceiver unit 2910 is further configured to receive an update request message sent by the currently activated network device through the connection path. The update request message is configured to request the first network device to update the mobility configuration.

In some embodiments, the transceiver unit 2910 is specifically configured to send the update message or the cancel message to the currently activated network device through the connection path.

In some embodiments, the transceiver unit 2910 is further configured to: in response to an absence of a mobility configuration related to the terminal in the first network device, send first indication information to a network device storing the node path table. The first indication information is configured for the network device storing the node path table to delete the first network device and a path connected to the first network device in the node path table.

In some embodiments, the transceiver unit 2910 is further configured to: in response to a change of the currently activated network device, receive a second change notification message sent by an activated network device before the change or an activated network device after the change. The second change notification message is configured to notify that the currently activated network device is changed.

In some embodiments, the currently activated network device has a connection path with the first network device.

In some embodiments, the transceiver unit 2910 is further configured to receive an update request message sent by the currently activated network device based on a network device adding the currently activated network device. The update request message is configured to request the first network device to update the mobility configuration.

In some embodiments, the transceiver unit 2910 is specifically configured to send the update message or the cancel message to the currently activated network device based on a network device adding the first network device.

In some embodiments, the transceiver unit 2910 is further configured to release resources reserved for the terminal; and/or release a context of the terminal stored in the first network device.

In some embodiments, first information is carried by one or more of the update message, the cancel message and the update request message. The first information is configured to explicitly or implicitly indicate that one or more of the update message, the cancel message and the update request message is suitable for a selective activation of cells and/or cell groups.

The mobility configuration apparatus of this embodiment may send the update message or the cancel message to the second network device, the update message is configured to update the mobility configuration of the terminal, and the cancel message is configured to cancel the mobility operation corresponding to the first network device in the terminal, so that the network device may cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

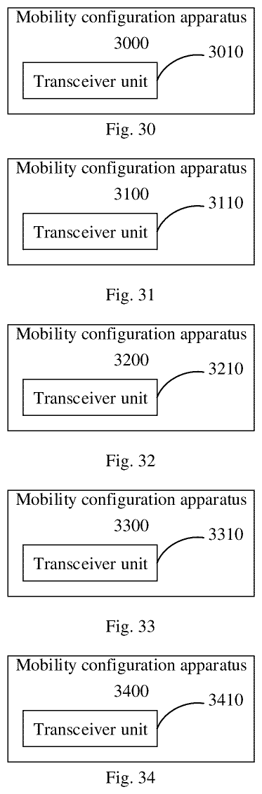

Referring to FIG. 30, FIG. 30 is a schematic diagram of a mobility configuration apparatus provided by an embodiment of the present disclosure.

As shown in FIG. 30, a mobility configuration apparatus 3000 includes a transceiver unit 3010.

The transceiver unit 3010, configured to receive a cancel message sent by a second network device;

The cancel message is configured to cancel a mobility operation corresponding to a first network device in a terminal.

In some embodiments, the first network device is a network device to be activated, and the second network device is any one of: an anchor network device; and a currently activated network device. The network device to be activated is a network device corresponding to a cell or cell group to be activated; and the currently activated network device is a network device corresponding to a currently activated cell or cell group.

In some embodiments, the anchor network device has a connection with the first network device, and the anchor network device has a connection with the currently activated network device.

In some embodiments, the transceiver unit 3010 is specifically configured to receive the cancel message sent by the currently activated network device through the anchor network device.

In some embodiments, the currently activated network device has a connection with each network device to be activated.

In some embodiments, the transceiver unit 3010 is further configured to obtain a connection path between the currently activated network device and the first network device from a node path table. The node path table includes one or more of: an initially activated network devices, each network device to be activated added by the initially activated network device, and each network device to be activated added by a subsequently activated network device. Two network devices in the node path table have a direct or indirect connection path therebetween.

In some embodiments, the transceiver unit 3010 is specifically configured to receive the cancel message sent by the currently activated network device through the connection path.

In some embodiments, the currently activated network device has a connection path with the first network device.

In some embodiments, the transceiver unit 3010 is specifically configured to receive the cancel message sent by the currently activated network device based on a network device adding the currently activated network device.

In some embodiments, the transceiver unit 3010 is further configured to, according to the cancel message, release resources reserved for the terminal; and/or release a context of the terminal stored in the first network device.

The mobility configuration apparatus of this embodiment may receive the cancel message sent by the second network device, the cancel message is configured to cancel the mobility operation corresponding to the first network device in the terminal, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 31, FIG. 31 is a schematic diagram of a mobility configuration apparatus provided by an embodiment of the present disclosure.

As shown in FIG. 31, a mobility configuration apparatus 3100 includes a transceiver unit 3110.

The transceiver unit 3110 is configured to receive an update message or a cancel message sent by a first network device.

The transceiver unit 3110 is further configured to send the update message or the cancel message to a terminal.

A currently activated network device is a network device corresponding to a currently activated cell or cell group, the update message is configured to update a mobility configuration of the terminal, and the cancel message is configured to cancel a mobility operation corresponding to the first network device in the terminal.

In some embodiments, the first network device is a network device to be activated. The network device to be activated is a network device corresponding to a cell or cell group to be activated.

In some embodiments, the anchor network device has a connection with the first network device, and the anchor network device has a connection with the currently activated network device.

In some embodiments, the transceiver unit 3110 is further configured to send an update request message to the first network device through the anchor network device. The update request message is configured to request the first network device to update the mobility configuration.

In some embodiments, the transceiver unit 3110 is specifically configured to receive the update message or the cancel message sent by the first network device through the anchor network device.

In some embodiments, the transceiver unit 3110 is further configured to: in response to a change of the anchor network device, receive a first change notification message sent by an anchor network device before the change or an anchor network device after the change. The first change notification message is configured to notify that the anchor network device is changed.

In some embodiments, the currently activated network device has a connection with each network device to be activated.

In some embodiments, the transceiver unit 3110 is further configured to send an update request message to the first network device. The update request message is configured to request the first network device to update the mobility configuration.

In some embodiments, the transceiver unit 3110 is further configured to: in response to a change of the currently activated network device, send a second change notification message to the first network device. The second change notification message is configured to notify that the currently activated network device is changed.

In some embodiments, the transceiver unit 3110 is further configured to obtain a connection path between the currently activated network device and the first network device from a node path table. The node path table includes one or more of: an initially activated network device, each network device to be activated added by the initially activated network device, and each network device to be activated added by a subsequently activated network device. Two network devices in the node path table have a direct or indirect connection path therebetween.

In some embodiments, the transceiver unit 3110 is further configured to send an update request message to the first network device through the connection path. The update request message is configured to request the first network device to update the mobility configuration.

In some embodiments, the transceiver unit 3110 is specifically configured to receive the update message or the cancel message sent by the first network device through the connection path.

In some embodiments, the transceiver unit 3110 is further configured to: in response to an absence of a mobility configuration related to the terminal in the first network device, send first indication information to a network device storing the node path table. The first indication information is configured for the network device storing the node path table to delete the first network device and a path connected to the first network device in the node path table.

In some embodiments, the transceiver unit 3110 is further configured to: in response to a change of the currently activated network device, send a second change notification message to the first network device. The second change notification message is configured to notify that the currently activated network device is changed.

In some embodiments, the currently activated network device has a connection path with the first network device.

In some embodiments, the transceiver unit 3110 is further configured to send an update request message to the first network device based on a network device adding the currently activated network device. The update request message is configured to request the first network device to update the mobility configuration.

In some embodiments, the transceiver unit 3110 is specifically configured to receive the update message or the cancel message sent by the first network device based on a network device adding the first network device.

In some embodiments, first information is carried by one or more of the update message, the cancel message and the update request message. The first information is configured to explicitly or implicitly indicate that one or more of the update message, the cancel message and the update request message is suitable for a selective activation of cells and/or cell groups.

The mobility configuration apparatus of this embodiment may send the update message or the cancel message to the terminal by receiving the update message or the cancel message sent by the first network device, so that the network device may cancel the mobility operation of the terminal or update the mobility configuration of the terminal through information interaction between nodes, so as to update the mobility configuration or cancel the inappropriate mobility operation in time, thus effectively improving the reliability of mobility, enhancing the communication efficiency of the system, and reducing the waste of resources.

Referring to FIG. 32, FIG. 32 is a schematic diagram of a mobility configuration apparatus provided by an embodiment of the present disclosure.

As shown in FIG. 32, a mobility configuration apparatus 3200 includes a transceiver unit 3210.

The transceiver unit 3210 is configured to send a cancel message to a first network device.

The transceiver unit 3210 is further configured to send the cancel message to a terminal.

A currently activated network device is a network device corresponding to a currently activated cell or cell group, and the cancel message is configured to cancel a mobility operation corresponding to the first network device in the terminal.

In some embodiments, the first network device is a network device to be activated. The network device to be activated is a network device corresponding to a cell or cell group to be activated.

In some embodiments, the anchor network device has a connection with the first network device, and the anchor network device has a connection with the currently activated network device.

In some embodiments, the transceiver unit 3210 is specifically configured to send the cancel message to the first network device through the anchor network device.

In some embodiments, the currently activated network device has a connection with each network device to be activated.

In some embodiments, the transceiver unit 3210 is further configured to obtain a connection path between the currently activated network device and the first network device from a node path table. The node path table includes one or more of: an initially activated network device, each network device to be activated added by the initially activated network device, and each network device to be activated added by a subsequently activated network devices. Two network devices in the node path table have a direct or indirect connection path therebetween.

In some embodiments, the transceiver unit 3210 is specifically configured to send the cancel message to the first network device through the connection path.

In some embodiments, the currently activated network device has a connection path with the first network device.

In some embodiments, the transceiver unit 3210 is specifically configured to send the cancel message to the first network device based on a network device adding the currently activated network device.

In some embodiments, the cancel message is configured for the first network device to release resources reserved for the terminal; and/or for the first network device to release a context of the terminal stored in the first network device.

The mobility configuration apparatus of this embodiment may send the cancel message to the first network device and send the cancel message to the terminal, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

Referring to FIG. 33, FIG. 33 is a schematic diagram of a mobility configuration apparatus provided by an embodiment of the present disclosure.

As shown in FIG. 33, a mobility configuration apparatus 3300 includes a transceiver unit 3310.

The transceiver unit 3310 is configured to receive an update message or a cancel message sent by a first network device.

The transceiver unit 3310 is further configured to send the update message or the cancel message to a currently activated network device.

The currently activated network device is a network device corresponding to a currently activated cell or cell group, the update message is configured to update a mobility configuration of the terminal, and the cancel message is configured to cancel a mobility operation corresponding to the first network device in the terminal.

In some embodiments, the first network device is a network device to be activated. The network device to be activated is a network device corresponding to a cell or cell group to be activated. The anchor network device and each network device to be activated have a connection therebetween, and the anchor network device has a connection with the currently activated network device.

In some embodiments, the transceiver unit 3310 is further configured to send an update request message to the first network device.

In some embodiments, the transceiver unit 3310 is further configured to receive an update request message sent by the currently activated network device; and send the update request message to the first network device. The update request message is configured to request the first network device to update the mobility configuration.

In some embodiments, the transceiver unit 3310 is further configured to: in response to a change of the anchor network device, send a first change notification message to the first network device. The first change notification message is configured to notify that the anchor network device is changed.

In some embodiments, the first information is carried by one or more of the update message, the cancel message and the update request message. The first information is configured to explicitly or implicitly indicate that one or more of the update message, the cancel message and the update request message is suitable for a selective activation of cells and/or cell groups.

The mobility configuration apparatus of this embodiment may receive the update message or the cancel message sent by the first network device and send the update message or the cancel message to the currently activated network device, so that the network device may cancel the mobility operation of the terminal or update the mobility configuration of the terminal through information interaction between nodes, so as to update the mobility configuration or cancel the inappropriate mobility operation in time, effectively improving the reliability of mobility, enhancing the communication efficiency of the system, and reducing the waste of resources.

Referring to FIG. 34, FIG. 34 is a schematic diagram of a mobility configuration apparatus provided by an embodiment of the present disclosure.

As shown in FIG. 34, a mobility configuration apparatus 3400 includes a transceiver unit 3410.

The transceiver unit 3410 is configured to send a cancel message to a first network device.

The cancel message is configured to cancel a mobility operation corresponding to the first network device in a terminal.

In some embodiments, the first network device is a network device to be activated. The network device to be activated is a network device corresponding to a cell or cell group to be activated. There is a connection between an anchor network device and each network device to be activated, and there is a connection between the anchor network device and a currently activated network device.

In some embodiments, the transceiver unit 3410 is further configured to send the cancel message to the currently activated network device. The currently activated network device is a network device corresponding to a currently activated cell or cell group.

In some embodiments, the transceiver unit 3410 is further configured to receive the cancel message sent by the currently activated network device. The currently activated network device is a network device corresponding to a currently activated cell or cell group.

In some embodiments, the cancel message is configured for the first network device to release resources reserved for the terminal; and/or for the first network device to release a context of the terminal stored in the first network device.

The mobility configuration apparatus of this embodiment may send the cancel message to the first network device, so that the network device may cancel the mobility operation of the terminal through information interaction between nodes, so as to cancel the inappropriate mobility operation in time, thus effectively improving the reliability of mobility, enhancing the communication efficiency of the system and reducing the waste of resources.

In order to realize the above embodiments, the embodiment of the present disclosure also proposes a communication device, which includes a processor and a memory, a computer program is stored in the memory, and the processor executes the computer program stored in the memory, so that the device may execute the methods shown in the embodiments of FIGS. 2 to 27.

In order to realize the above embodiments, the embodiment of the present disclosure also proposes a communication device, which includes a processor and an interface circuit, the interface circuit is configured to receive code instructions and transmit the code instructions to the processor, and the processor is configured to execute the code instructions to execute the methods shown in the embodiments of FIGS. 2 to 27.

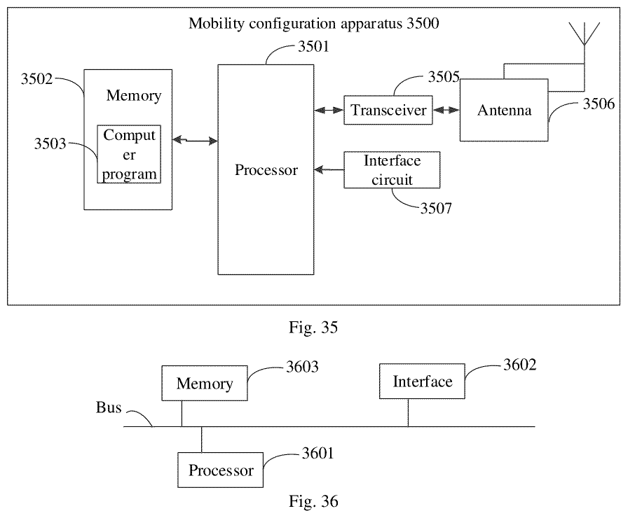

Referring to FIG. 35, FIG. 35 is a schematic diagram of another mobility configuration apparatus provided by an embodiment of the present disclosure. A mobility configuration apparatus 3500 may be a network device, or may be a chip, a chip system, or a processor that supports the network device to realize the above methods. The apparatus may be used to realize the methods described in the above method embodiments, and for details, reference may be made to the descriptions in the above method embodiments.

The mobility configuration apparatus 3500 may include one or more processors 3501. The processor 3501 may be a general-purpose processor or a special-purpose processor or the like, for example, a baseband processor or a central processing unit. The baseband processor may be used to process communication protocols and communication data, and the central processor may be used to control the mobility configuration apparatus (such as a base station, a baseband chip, a terminal, a terminal chip, a DU or a CU, etc.), execute computer programs, and process data of computer programs.

In some embodiments, the mobility configuration apparatus 3500 may further include one or more memories 3502, on which a computer program 3503 may be stored, and the processor 3501 executes the computer program 3503, so that the mobility configuration apparatus 3500 executes the methods described in the above method embodiments. The computer program 3503 may be cured in the processor 3501, in which case, the processor 3501 may be implemented by hardware.

In some embodiments, data may also be stored in the memory 3502. The mobility configuration apparatus 3500 and the memory 3502 may be arranged separately or integrated together.

In some embodiments, the mobility configuration apparatus 3500 may further include a transceiver 3505 and an antenna 3506. The transceiver 3505 may be called a transceiver unit, a transceiving machine, a transceiver circuit, etc., and is configured to realize the transceiver function. The transceiver 3505 may include a receiver and a transmitter. The receiver may be called a receiving machine or a receiving circuit, etc., for realizing the receiving function. The transmitter may be called a transmitting machine or a transmitting circuit, etc., for realizing the transmitting function.

In some embodiments, the mobility configuration apparatus 3500 may further include one or more interface circuits 3507. The interface circuit 3507 is configured to receive code instructions and transmit the code instructions to the processor 3501. The processor 3501 executes the code instructions to cause the mobility configuration apparatus 3500 to perform the methods described in the above method embodiments.

In an implementation, the processor 3501 may include a transceiver for realizing the receiving and transmitting functions. For example, the transceiver may be a transceiver circuit, or an interface, or an interface circuit. The transceiver circuits, interfaces or interface circuits for realizing the receiving and transmitting functions may be separated or integrated. The transceiver circuit, interface or interface circuit may be configured for reading and writing codes/data, or the transceiver circuit, interface or interface circuit may be configured for signal transmission or transfer.

In an implementation, the mobility configuration apparatus 3500 may include a circuit, and the circuit may realize the function of transmitting or receiving or communicating in the aforementioned method embodiments. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, and the like. The processor and transceiver may also be manufactured by various IC process technologies, such as complementary metal oxide semiconductor (CMOS), negative channel metal oxide semiconductor (NMOS), positive channel metal oxide semiconductor (PMOS), bipolar junction transistor (BJT), bipolar CMOS (BICMOS), silicon germanium (SiGe), gallium arsenide (GaAs), etc.

The mobility configuration apparatus described in the above embodiments may be a network device or a terminal, but the scope of the mobility configuration apparatus described in the present disclosure is not limited to this, and the structure of the mobility configuration apparatus may not be limited by FIG. 29-FIG. 34. The mobility configuration apparatus may be a stand-alone device or may be part of a large device. For example, the mobility configuration apparatus may be:
(1) an independent integrated circuit IC, or a chip, or a chip system or subsystem;
(2) a set of one or more ICs, in some embodiments, the IC set may also include a storage component for storing data and computer programs;
(3) an ASIC, such as a modem;
(4) a module configured to be embedded in other devices;
(5) a receiver, a terminal, an intelligent terminal, a cellular phone, a wireless equipment, a handset, a mobile unit, a vehicle-mounted device, a network device, a cloud device, an artificial intelligence device, etc.
(6) others and so on.

In a case that the mobility configuration apparatus may be a chip or a chip system, reference may be made to a schematic diagram of a chip shown in FIG. 36. The chip shown in FIG. 36 includes a processor 3601 and an interface 3602. One or more processors 3601 may be provided, and a plurality of interfaces 3602 may be provided.

In a case that the chip is configured to realize the functions of the network device in the embodiments of the present disclosure, the interface 3602 is configured to receive code instructions and transmit the code instructions to the processor, and the processor 3601 is configured to run the code instructions to execute the methods as shown in FIGS. 2 to 27.

In some embodiments, the chip further includes a memory 3603 for storing necessary computer programs and data.

Those skilled in the art my also understand that various illustrative logical blocks and steps listed in the embodiments of the present disclosure may be implemented by electronic hardware, computer software, or a combination of both. Whether this function is realized by hardware or software depends on the specific application and the design requirements of the whole system. Those skilled in the art may use various methods to realize the functions for each specific application, but this realization should not be understood to be beyond the scope of protection of the embodiments of the present disclosure.

The embodiment of the present disclosure also provides a communication system, which includes the mobility configuration apparatus serving as the network device in the embodiments of FIG. 29-FIG. 34, or the system includes the mobility configuration apparatus serving as the network device in the embodiment of FIG. 35.

The present disclosure also provides a readable storage medium, on which instructions are stored, which, when executed by a computer, realize the functions of any of the above method embodiments.

The present disclosure also provides a computer program product which, when executed by a computer, realizes the functions of any of the above method embodiments.

The above embodiments may be realized fully or partially by software, hardware, firmware or any combination thereof. When implemented in software, they be fully or partially implemented in the form of a computer program product. The computer program product includes one or more computer programs. When the computer programs are loaded and executed on a computer, the flows or functions according to the embodiments of the present disclosure is generated in whole or in part. The computer may be a general-purpose computer, a special-purpose computer, a computer network, or other programmable devices. The computer program may be stored in a computer-readable storage medium or transmitted from one computer-readable storage medium to another. For example, the computer program may be transmitted from a website, computer, server or data center to another website, computer, server or data in a wired manner (such as a coaxial cable, an optical fiber, a digital subscriber line (DSL)) or in a wireless manner (such as infrared, WiFi, microwave, etc.). The computer-readable storage medium may be any available medium that the computer may access or a data storage device such as a server and a data center that contains one or more available media. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)) and the like.

It may be understood by those skilled in the art that numerical numbers such as first and second involved in the present disclosure are only for the convenience of description, and are not intended to limit the scope of the embodiments of the present disclosure, and also do not indicate the sequence.

The phrase “at least one” in the present disclosure may also be described as one or more, and the phrase “a plurality of” may be two, three, four or more, which is not limited in the present disclosure. In the embodiments of the present disclosure, for a technical feature, the technical features are distinguished by “first”, “second”, “third”, “A”, “B”, “C” and “D”. The technical features described by “first”, “second”, “third”, “A”, “B”, “C” and “D” do not have a sequential order or a size order.

The corresponding relationships shown in each table in the present disclosure may be configured or predefined. The values of information in each table are only examples, and may be configured as other values, which is not limited in the present disclosure. When configuring the corresponding relationship between information and parameters, it is not necessary to configure all the corresponding relationships indicated in each table. For example, in the table of the present disclosure, the corresponding relationships shown in some rows may not be configured. For another example, appropriate deformation adjustments may be made based on the above tables, such as splitting, merging and so on. The names of the parameters indicated by the headings in the above tables may also be other names that may be understood by the communication device, and the values or representations of the parameters may also be other values or representations that may be understood by the communication device. Other data structures may also be used when the above tables are implemented, such as arrays, queues, containers, stacks, linear tables, pointers, linked lists, trees, graphs, structures, classes, heaps, hash tables, etc.

Pre-definition in the present disclosure may be understood as definition, definition in advance, storage, pre-storage, pre-negotiation, pre-configuration, curing, or pre-programming.

Those ordinary skilled in the art may realize that the units and algorithm steps of various examples described in connection with the embodiments disclosed herein may be implemented in electronic hardware, or a combination of computer software and electronic hardware. Whether these functions are implemented in hardware or software depends on the specific application and design constraints of the technical solution. The skilled may use different methods to realize the described functions for each specific application, but this implementation should not be considered to be beyond the scope of the present disclosure.

It may be clearly understood by those skilled in the art that for the convenience and conciseness of description, the specific working processes of the systems, apparatuses and units described above may refer to the corresponding processes in the aforementioned method embodiments, and will not be repeated here.

It should be understood that the steps may be reordered, added or deleted using the various forms of flows shown above. For example, the steps described in the embodiments of the present disclosure may be executed in parallel, sequentially or in a different order, as long as the desired result of the technical solution disclosed in the present disclosure may be achieved, which is not limited here.

The above specific embodiments do not limit the scope of protection of the present disclosure. It should be understood by those skilled in the art that various modifications, combinations, sub-combinations and substitutions may be made according to design requirements and other factors. Any modification, equivalent substitution and improvement made within the spirit and principle of the present disclosure should be included in the protection scope of the present disclosure.

1. A mobility configuration method, performed by a first network device, comprising:
sending an update message or a cancel message to a second network device,
wherein the update message is configured to update a mobility configuration of a terminal, and the cancel message is configured to cancel a mobility operation corresponding to the first network device in the terminal.

2. The method according to claim 1, wherein the first network device is a network device to be activated, and the second network device is
a currently activated network device; and
wherein the network device to be activated is a network device corresponding to a cell or cell group to be activated; and
the currently activated network device is a network device corresponding to a currently activated cell or cell group.

3.-6. (canceled)

7. The method according to claim 2, wherein the currently activated network device has a connection with each network device to be activated,
wherein the method further comprises:
receiving an update request message sent by the currently activated network device, and
in response to a change of the currently activated network device, receiving a second change notification message sent by an activated network device before the change or an activated network device after the change,
wherein the update request message is configured to request the first network device to update the mobility configuration, and the second change notification message is configured to notify that the currently activated network device is changed.

8. (canceled)

9. (canceled)

10. The method according to claim 2, further comprising:
acquiring a connection path between the currently activated network device and the first network device from a node path table,
wherein the node path table includes one or more of: an initially activated network device, each network device to be activated added by the initially activated network device, and each network device to be activated added by a subsequently activated network device; and
wherein two network devices in the node path table have a direct or indirect connection path therebetween.

11.-14. (canceled)

15. The method according to claim 2, wherein a connection path is arranged between the currently activated network device and the first network device,
wherein the method further comprises:
receiving an update request message sent by the currently activated network device based on a network device adding the currently activated network device,
wherein the update request message is configured to request the first network device to update the mobility configuration.

16.-19. (canceled)

20. A mobility configuration method, performed by a first network device, and comprising:
receiving a cancel message sent by a second network device,
wherein the cancel message is configured to cancel a mobility operation corresponding to the first network device in the terminal.

21. The method according to claim 20, wherein the first network device is a network device to be activated, and the second network device is
a currently activated network device,
wherein the network device to be activated is a network device corresponding to a cell or cell group to be activated; and
the currently activated network device is a network device corresponding to a currently activated cell or cell group.

22. (canceled)

23. (canceled)

24. The method according to claim 21, wherein the currently activated network device has a connection with each network device to be activated.

25. The method according to claim 21, further comprising:
acquiring a connection path between the currently activated network device and the first network device from a node path table,
wherein the node path table comprises one or more of: an initially activated network device, each network device to be activated added by the initially activated network device, and each network device to be activated added by a subsequently activated network device; and
wherein two network devices in the node path table have a direct or indirect connection path therebetween.

26. (canceled)

27. The method according to claim 21, wherein the currently activated network device has a connection path with the first network device,
wherein receiving the cancel message sent by the second network device comprises:
receiving the cancel message sent by the currently activated network device based on a network device adding the currently activated network device.

28. (canceled)

29. (canceled)

30. A mobility configuration method, performed by a currently activated network device, comprising:
receiving an update message or a cancel message sent by a first network device; and
sending the update message or the cancel message to a terminal,
wherein the currently activated network device is a network device corresponding to a currently activated cell or cell group, the update message is configured to update a mobility configuration of the terminal, and the cancel message is configured to cancel a mobility operation corresponding to the first network device in the terminal.

31. The method according to claim 30, wherein the first network device is a network device to be activated; and
the network device to be activated is a network device corresponding to a cell or cell group to be activated.

32.-35. (canceled)

36. The method according to claim 31, wherein the currently activated network device has a connection with each network device to be activated,
wherein the method further comprises:
sending an update request message to the first network device, and
sending a second change notification message to the first network device in response to a change of the currently activated network device,
wherein the update request message is configured to request the first network device to update the mobility configuration, and the second change notification message is configured to notify that the currently activated network device is changed.

37. (canceled)

38. (canceled)

39. The method according to claim 31, further comprising:
acquiring a connection path between the currently activated network device and the first network device from a node path table,
wherein the node path table comprises one or more of: an initially activated network device, each network device to be activated added by the initially activated network device, and each network device to be activated added by a subsequently activated network device; and
wherein two network devices in the node path table have a direct or indirect connection path therebetween.

40.-43. (canceled)

44. The method according to claim 31, wherein the currently activated network device has a connection path with the first network device,
wherein the method further comprises:
sending an update request message to the first network device based on a network device adding the currently activated network device,
wherein the update request message is configured to request the first network device to update the mobility configuration,
and wherein receiving the update message or the cancel message sent by the first network device comprises:
receiving the update message or the cancel message sent by the first network device based on a network device adding the first network device.

45.-47. (canceled)

48. A mobility configuration method, performed by a currently activated network device, and comprising:
sending a cancel message to a first network device; and
sending the cancel message to the terminal;
wherein the currently activated network device is a network device corresponding to a currently activated cell or cell group, and the cancel message is configured to cancel a mobility operation corresponding to the first network device in the terminal.

49. The method according to claim 48, wherein the first network device is a network device to be activated; and
the network device to be activated is a network device corresponding to a cell or cell group to be activated.

50.-52. (canceled)

53. The method according to claim 49, further comprising:
acquiring a connection path between the currently activated network device and the first network device from a node path table,
wherein a node path table includes one or more of: an initially activated network device, each network device to be activated added by the initially activated network device, and each network device to be activated added by a subsequently activated network device; and
wherein two network devices in the node path table have a direct or indirect connection path therebetween,
wherein sending the cancel message to the first network device comprises:
sending the cancel message to the first network device through the connection path.

54. (canceled)

55. The method according to claim 49, wherein a connection path is arranged between the currently activated network device and the first network device,
wherein sending the cancel message to the first network device comprises:
sending the cancel message to the first network device based on a network device adding the currently activated network device.

56.-74. (canceled)

75. A communication device, comprising a processor and a memory, wherein a computer program is stored in the memory, and the processor executes the computer program stored in the memory, so that the device performs the method according to claim 1.

76. (canceled)

77. (canceled)
